(19) United States
(12) Patent Application Publication
(10) Pub. No.: US 2026/0113483 A1
(43) Pub. Date: Apr. 23, 2026

(54) ENCODING AND DECODING METHODS, BITSTREAM, ENCODERS, DECODERS, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(21) Appl. No.: 19/429,121

(22) Filed: Dec. 22, 2025

Related U.S. Application Data
(63) Continuation of application No. PCT/CN2023/105693, filed on Jul. 4, 2023.

(51) Int. Cl. H04N 19/593; H04N 19/105; H04N 19/159; H04N 19/186

(52) U.S. Cl. CPC H04N 19/593; H04N 19/105; H04N 19/159; H04N 19/186

(57) ABSTRACT

The present application discloses a decoding method, which comprises: obtaining prediction mode reference information of a current chroma block; in a case where the prediction mode reference information meets a usage condition of a first intra prediction mode, decoding a first syntax element flag; determining, based on the first syntax element flag, whether the current chroma block uses the first intra prediction mode; in a case where the prediction mode reference information does not meet the usage condition of the first intra prediction mode, decoding a second syntax element flag; and determining, based on the second syntax element flag, whether the current chroma block uses a second intra prediction mode.

### CROSS-REFERENCE TO RELATED APPLICATION

This application is a Continuation Application of International Application No. PCT/CN2023/105693 filed on Jul. 4, 2023, which is incorporated herein by reference in its entirety.

### TECHNICAL FIELD

The present disclosure relates to the field of video encoding and decoding technology, and in particular to, encoding and decoding methods, a bitstream, encoders, decoders, and a storage medium.

### RELATED ART

A direct mode (DM) mode is a chroma intra prediction mode in which chroma depends on luma. For example, in a case where a chroma block selects the DM mode, the chroma block is to find a luma block at the corresponding position, and the chroma block determines its own prediction mode based on an intra prediction mode of the found luma block.

In an exploratory model, i.e., enhanced compression model (ECM), of a next-generation coding standard H.266/versatile video coding (VVC), an intra direct block vector (intraDBV) mode is added for chroma prediction of an intra block. The intraDBV mode is also a chroma intra prediction mode in which the chroma depends on the luma. A block vector (BV) of the chroma block is determined based on a block vector of the luma block at the corresponding position, so as to determine a reference block of the chroma block.

However, there is certain functional redundancy between the DM mode and the IntraDBV mode, which causes lower encoding and decoding efficiency of the existing DM mode and IntraDBV mode.

### SUMMARY

The disclosure provides encoding and decoding methods, a bitstream, encoders, decoders, and a storage medium.

Technical solutions of the present disclosure may be implemented as follows.

In a first aspect, embodiments of the present disclosure provide a decoding method, which is applied to a decoder and includes:
obtaining prediction mode reference information of a current chroma block;
in a case where the prediction mode reference information meets a usage condition of a first intra prediction mode, decoding a first syntax element flag;
determining, based on the first syntax element flag, whether the current chroma block uses the first intra prediction mode;
in a case where the prediction mode reference information does not meet the usage condition of the first intra prediction mode, decoding a second syntax element flag; and
determining, based on the second syntax element flag, whether the current chroma block uses a second intra prediction mode.

In a second aspect, the embodiments of the present disclosure provide a decoding method, which is applied to a decoder and includes:
decoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

In a third aspect, the embodiments of the present disclosure provide an encoding method, which is applied to an encoder and includes:
obtaining prediction mode reference information of a current chroma block;
in a case where the prediction mode reference information meets a usage condition of a first intra prediction mode, encoding a first syntax element flag;
determining, based on the first syntax element flag, whether the current chroma block uses the first intra prediction mode;
in a case where the prediction mode reference information does not meet the usage condition of the first intra prediction mode, encoding a second syntax element flag; and
determining, based on the second syntax element flag, whether the current chroma block uses a second intra prediction mode.

In a fourth aspect, the embodiments of the present disclosure provide an encoding method, which is applied to an encoder and includes:
encoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

In a fifth aspect, the embodiments of the present disclosure provide a bitstream, which is generated by bit encoding based on information to be encoded; where the information to be encoded includes at least one of:
a first syntax element flag used for indicating whether to use a first intra prediction mode, a second syntax element flag used for indicating whether to use a second intra prediction mode, a third syntax element flag used for indicating whether the first intra prediction mode and the second intra prediction mode are allowed to be used, a syntax element flag used for indicating a weighted prediction mode, other syntax element flags used for indicating other intra prediction modes, or a syntax element flag used for indicating a cross-component intra prediction mode.

In a sixth aspect, the embodiments of the present disclosure provide an encoder, which includes a first obtaining unit, an encoding unit, and a first determining unit; where
the first obtaining unit is configured to obtain prediction mode reference information of a current chroma block;
the encoding unit is configured to: in a case where the prediction mode reference information meets a usage condition of a first intra prediction mode, encode a first syntax element flag; and
the first determining unit is configured to determine, based on the first syntax element flag, whether the current chroma block uses the first intra prediction mode,
wherein the encoding unit is further configured to: in a case where the prediction mode reference information does not meet the usage condition of the first intra prediction mode, encode a second syntax element flag; and
the first determining unit is further configured to determine, based on the second syntax element flag, whether the current chroma block uses a second intra prediction mode.

In a seventh aspect, the embodiments of the present disclosure provide an encoder, which includes a first obtaining unit, an encoding unit, and a first determining unit; where
the encoding unit is configured to encode a third syntax element flag of a current chroma block;
the first obtaining unit is configured to: in a case of determining, based on the third syntax element flag, that the current chroma block is allowed to use a first intra prediction mode and a second intra prediction mode, obtain prediction mode reference information of the current chroma block;
the first determining unit is configured to: in a case where the prediction mode reference information meets a usage condition of the first intra prediction mode, determine that the current chroma block uses the first intra prediction mode; and
the first determining unit is further configured to: in a case where the prediction mode reference information does not meet the usage condition of the first intra prediction mode, determine that the current chroma block uses the second intra prediction mode.

In an eighth aspect, the embodiments of the present disclosure provide an encoder, which includes a first memory and a first processor; where
the first memory is configured to store a computer program executable on the first processor; and
the first processor is configured to: perform, when running a computer program, the methods according to the third aspect and the fourth aspect.

In a ninth aspect, the embodiments of the present disclosure provide a decoder, which includes:
a second obtaining unit, configured to obtain prediction mode reference information of a current chroma block;
a decoding unit, configured to: in a case where the prediction mode reference information meets a usage condition of a first intra prediction mode, decode a first syntax element flag; and
a second determining unit, configured to determine, based on the first syntax element flag, whether the current chroma block uses the first intra prediction mode,
where the decoding unit is further configured to: in a case where the prediction mode reference information does not meet the usage condition of the first intra prediction mode, decode a second syntax element flag; and
the second determining unit is further configured to determine, based on the second syntax element flag, whether the current chroma block uses a second intra prediction mode.

In a tenth aspect, the embodiments of the present disclosure provide a decoder, which includes:
a decoding unit, configured to decode a third syntax element flag of a current chroma block;
a second obtaining unit, configured to: in a case of determining, based on the third syntax element flag, that the current chroma block is allowed to use a first intra prediction mode and a second intra prediction mode, obtain prediction mode reference information of the current chroma block; and
a second determining unit, configured to: in a case where the prediction mode reference information meets a usage condition of the first intra prediction mode, determine that the current chroma block uses the first intra prediction mode;
where the second determining unit is further configured to: in a case where the prediction mode reference information does not meet the usage condition of the first intra prediction mode, determine that the current chroma block uses the second intra prediction mode.

In an eleventh aspect, the embodiments of the present disclosure provide a decoder, which includes a second memory and a second processor; where
the second memory is configured to store a computer program executable on the second processor; and
the second processor is configured to: perform, when running a computer program, the methods according to the first aspect and the second aspect.

In a twelfth aspect, the embodiments of the present disclosure provide a non-transitory computer-readable storage medium, where the non-transitory computer-readable storage medium stores a computer program, and when the computer program is executed, the methods according to the first aspect to the fourth aspect are implemented.

The embodiments of the present disclosure provide encoding and decoding methods, a bitstream, encoders, decoders, and a storage medium. In a case of encoding and decoding a chroma component, it is considered that there is functional redundancy of some intra prediction modes, in a case where prediction mode reference information meets an usage condition of the first intra prediction mode, only the first syntax element flag is encoded/decoded, it is determined whether the current chroma block uses the first intra prediction mode based on the first syntax element flag, and encoding/decoding of a syntax element flag related to the second intra prediction mode is skipped, that is, the current chroma block does not use the second intra prediction mode. In a case where the prediction mode reference information does not meet the usage condition of the first intra prediction mode, only the second syntax element flag is encoded/decoded, it is determined whether the current chroma block uses the second intra prediction mode based on the second syntax element flag; and encoding/decoding of a syntax element flag related to the first intra prediction mode is skipped, that is, the current chroma block does not use the first intra prediction mode.

In addition, the third syntax element flag may be used for simultaneously indicating whether the first intra prediction mode and the second intra prediction mode are allowed to be used. In a case that the first intra prediction mode and the second intra prediction mode are allowed to be used, it is determined whether the prediction mode reference information meets the usage condition of the first intra prediction mode. In a case that the prediction mode reference information meets the usage condition of the first intra prediction mode, it may be directly determined that the current chroma block uses the first intra prediction mode. In a case that the prediction mode reference information does not meet the usage condition of the first intra prediction mode, it is determined that the current chroma block uses the second intra prediction mode.

### BRIEF DESCRIPTION OF THE DRAWINGS

FIG. 1 is a schematic diagram of a reference region of an intra template matching prediction (intra TMP).

FIG. 2A to FIG. 2F are schematic diagrams of template types.

FIG. 3 is a schematic diagram of chroma and luma dual tree partitioning tree structures.

FIG. 4A is a schematic block diagram of composition of an encoder provided in embodiments of the present disclosure.

FIG. 4B is a schematic block diagram of composition of a decoder provided in the embodiments of the present disclosure.

FIG. 5 is a schematic diagram of network architecture of an encoding and decoding system provided in the embodiments of the present disclosure.

FIG. 6 is a first schematic flowchart of a decoding method provided in the embodiments of the present disclosure.

FIG. 7 is a second schematic flowchart of a decoding method provided in the embodiments of the present disclosure.

FIG. 8 is a first schematic flowchart of an encoding method provided in the embodiments of the present disclosure.

FIG. 9 is a second schematic flowchart of an encoding method provided in the embodiments of the present disclosure.

FIG. 10 is a schematic diagram of a composition structure of an encoder provided in the embodiments of the present disclosure.

FIG. 11 is a schematic diagram of a hardware structure of an encoder provided in the embodiments of the present disclosure.

FIG. 12 is a schematic diagram of a composition structure of a decoder provided in the embodiments of the present disclosure.

FIG. 13 is a schematic diagram of a hardware structure of a decoder provided in the embodiments of the present disclosure.

FIG. 14 is a schematic diagram of a composition structure of an encoding and decoding system provided in the embodiments of the present disclosure.

### DETAILED DESCRIPTION

In order to understand features and technical contents in the embodiments of the present disclosure in more detail, implementations in the embodiments of the present disclosure will be described in detail below in conjunction with the accompanying drawings. The accompanying drawings are used for reference only and are not used to limit the embodiments of the present disclosure.

Unless defined otherwise, all technical and scientific terms used here have the same meaning as commonly understood by one of ordinary skill in the art to which the present disclosure belongs. The terms used here are only for the purpose of describing the embodiments of the present disclosure and are not intended to limit the present disclosure.

In the following description, reference is made to “some embodiments”, which describes a subset of all possible embodiments, but it will be understood that “some embodiments” may be the same subset or different subsets of all possible embodiments, and may be combined with each other without conflict. It should also be pointed out that the terms “first\second\third” involved in the embodiments of the present disclosure are only used to distinguish similar objects and do not represent a specific ordering of the objects. It may be understood that “first\second\third” may be interchanged in a specific order or a sequence where permitted, so that the embodiments of the present disclosure described here may be implemented in an order other than that illustrated or described here.

Before the embodiments of the present disclosure are further described in detail, nouns and terms referred to the embodiments of the present disclosure will be described first. The nouns and terms referred to the embodiments of the present disclosure are applicable to following interpretations:
coding block (CB);
block matching (BM);
coding unit (CU);
block vector (BV);
sum of absolute difference (SAD);
sum of absolute transformed difference (SATD);
mean square error (MSE);
sum of squared differences (SSD);
mean absolute deviation (MAD);
mean square differences (MSD);
rate distortion optimization (RDO);
normalized correlation coefficient (NCC);
peak signal to noise ratio (PSNR);
single tree structure (single tree, ST);
dual tree structure (dual tree, DT);
chroma direct derived prediction mode (direct mode, DM);
chroma direct derived block vector prediction mode (intra direct block vector, intra DBV);
H.265/high efficiency video coding (HEVC);
H.265/HEVC screen content coding (SCC);
essential video coding (EVC);
H.266/versatile video coding (VVC);
reference software testing platform for VVC (VVC test model, VTM);
intra block copy (IBC);
intra template matching prediction (intra TMP);
cross component linear model (CCLM);
multi-models CCLM (MMLM);
convolutional cross-component intra prediction model (CCCM); and
reference software test platform for beyond VVC (enhanced compression model, ECM).

It may be understood that in a video picture, a first color component, a second color component, and a third color component are generally used for representing a coding block. Here, these three color components are a luma component, a blue chroma component and a red chroma component respectively. In some implementations, the luma component is generally represented by a symbol Y, the blue chroma component is generally represented by a symbol Cb or U, and the red chroma component is generally represented by a symbol Cr or V. In this way, the video picture may be represented in a YCbCr format or in a YUV format.

The single tree represents that luma and chroma components use the same partitioning tree structure when coding an intra-frame. In some implementations, a luma block and a chroma block in a coding tree unit (CTU) may be partitioned into the same tree structure.

The dual tree represents that different partitioning tree structures are allowed for luma and chroma components when coding an intra-frame. Since the luma component and the chroma component have fundamentally different levels of detail, the luma component has richer details and needs to be partitioned into smaller blocks for more refined prediction, while the chroma component is relatively flat and does not need to be partitioned into small blocks for refined prediction. A technology that uses different partitions for the luma component and the chroma component is introduced in the VVC. The dual tree is enabled in the CTU and is only allowed to be enabled in an intra-coded frame. In an inter-coded frame, the luma and chroma still use a partitioning tree structure (i.e., the single tree). Due to introduction of the dual tree technology, both luma and chroma components may achieve better coding effects respectively.

The IBC technology has been adopted since an HEVC expansion stage and is an effective tool for coding screen content. The IBC technology searches for the most suitable reference block for predicting a current block from an allowed reference region, and copies the most suitable reference block to predict the current block. A coordinate position difference between the reference block and the current block is referred as the block vector. The block vector consists of horizontal and vertical directions, and the BV is represented as:

$$B V = ( iHor , iVer )$$

Here, iHor is a coordinate difference in the horizontal direction, and iVer is a coordinate difference in the vertical direction.

The block vector is signaled into a bitstream through a binarized symbol for transmission, which is used for indicate a decoder to find the reference block in a case of using the IBC technology for prediction. Each coding unit has its own type. In the VVC and the ECM, these types include intra, inter, and the IBC. In a partitioning mode of the dual tree, the chroma coding unit may be of an intra type, while the luma coding unit at the corresponding position may be of an IBC type. In the single tree, since the luma and chroma are partitioned in the same way, a coding unit includes both luma and chroma components. Therefore, in a case where the coding unit type is the IBC type, both luma and chroma are of the IBC type. In this case, a block vector used for prediction by a chroma prediction mode is directly derived from a block vector of the luma block.

For example, the process of deriving a chroma BV based on a luma BV is as follows:
input: block vector luma (bvL) of luma ( 1/16 sample accuracy)
output: block vector chroma (bvC) of chroma ( 1/32 sample accuracy)

The derivation process may be either direct scaling or scaling followed by refinement using template matching (TM). Embodiments of the scaling operation are as follows:

$$b v C [ 0 ] = ( ( b v L [ 0 ] ≫ ( 3 + SubWidthC ) * 32 )$$

$$bvC [ 1 ] = ( ( b v L [ 1 ] ≫ ( 3 + SubWidthC ) * 32 )$$

The variables SubWidthC and SubHeightC depend on a chroma format sampling structure specified by a syntax element sps_chroma_format_idc, and a specific correspondence is as follows:

TABLE 1-1
Correspondence between sps_chroma_format_idc
and chroma format sampling structure

| | Color sampling | | |
|---|---|---|---|
| sps_chroma_format_idc | format | SubWidthC | SubHeightC |
| 0 | homochromy | 1 | 1 |
| 1 | 4:2:0 | 2 | 2 |
| 2 | 4:2:2 | 2 | 1 |
| 3 | 4:4:4 | 1 | 1 |

Embodiments of the refinement operation may be as follows.

The TM is used for refinement, that is, after obtaining the luma BV, an offset position is found by using a position of the chroma block and the BV, and a fine search is performed near the offset position by using a template, and an optimal BV is obtained with the minimum TMcost as a standard.

The IBC technology is used as an important tool for screen video coding in coding standards such as H.265/HEVC SCC, H.266/VVC, AOmedia video 1 (AV1), audio video standard (AVS3), and the EVC. In the exploratory model ECM of the next-generation coding standard H.266/VVC, the IBC technology continues to be used as a tool for the screen video coding, and the tool is expanded into a tool set that may be used in multiple modes and is further introduced into the coding field of ordinary natural videos, so as to become a more versatile video coding tool.

In addition, the ECM further includes the dual tree technology, the intraTMP technology, the DM technology and the intraDBV technology.

The intra TMP technology is a special intra prediction mode. Both an encoder and a decoder use a reconstructed region around the coding block as a template, find the best matching template in a predefined reconstructed region, and use a reconstructed value of a block corresponding to the best matching template as a prediction value of the current block.

The principle of the intraTMP is similar to that of the IBC technology. For the current prediction block, it is also necessary to find a reference block and then copy the reference block to a position of the current block as a prediction value. Different from the IBC, the block vector is not represented in the bitstream after binarization, but is found from a predefined region through template matching.

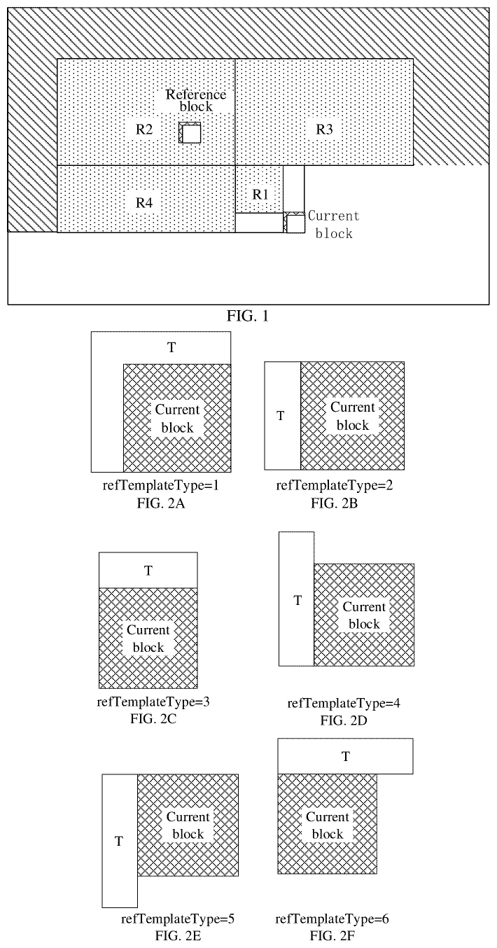

As illustrated in FIGS. 1, R1, R2, R3 and R4 are reference regions used by the current block for searching, and an L-shaped reconstructed region around the current block is a current block template. Based on a preset cost function, one or more L-shaped regions with the highest matching degree with the current block template are searched in the reference region, and found L-shaped reconstructed block(s) are used as prediction block(s) of the current block. In a case where intraTMP is used for the luma, the type of the luma coding block is intra.

In the embodiments of the present disclosure, the preset cost function may be the SAD, the SATD, the MSE, the SSD, the MAD, the MSD, the RDO, the NCC, or the like, which will not be limited here in detail.

Exemplarily, taking the SAD as an example, in this case, the cost function is as follows:

$$S A D ( {T}_{i} ) = {\sum }_{m = 0}^{M - 1} \vert {T}_{i , m} - {T}_{m} \vert , m = 0 , 1 , … , M - 1 \qquad ( 1 )$$

Here, Tᵢ represents a template in a search process, and M represents the number of samples in the template.

A prediction process of the intra TMP technology in the related art will be introduced in detail below.

Input of the intraTMP technology: a position of the current block (xTbCmp, yTbCmp), a width of the current block nTbW, and a height of the current block nTbH.

Output of the intraTMP technology: a predicted value predSamples[x][y] of the current block, where x=0 . . . nTbW−1 and y=0 . . . nTbH−1.

In some implementations, the prediction process of the intraTMP technology may be divided into four operations: determining a current template type, obtaining reconstructed samples of the current template, determining a block vector within a predefined search range, and generating the prediction value. In this way, the predicted value of the current block may be obtained through the above process. It should be noted that the intra TMP technology may be used for predicting the luma component or the chroma component, which will not be limited here in detail.

In the embodiments of the present disclosure, there are many cases involving use of the template and the template matching cost, which are explained here in a unified manner. The refTemplateType may be used for representing a template type, and the template type includes but is not limited to six types illustrated in FIG. 2A to FIG. 2F. FIG. 2A to FIG. 2F illustrate schematic diagrams of template types. As illustrated in FIG. 2A to FIG. 2F, a block filled with grids is the current block, and a neighbouring region of the current block is a template T. Six template types are illustrated here, which may be valid at the same time and selected for use by syntax elements, or may be used individually (e.g., only using type FIG. 2A).

Exemplarily, the six template types are as follows.

In a case where top-left reference samples, top reference samples, and left reference samples are all available, a value of refTemplateType is 1, and a template shape is as illustrated in FIG. 2A.

In a case where only the left reference samples are available, the value of refTemplateType is 2, and the template shape is illustrated in FIG. 2B.

In a case where only the top reference samples are available, the value of refTemplateType is 3, and the template shape is illustrated in FIG. 2C.

In a case where only the left reference samples and the top-left reference samples are available, the value of refTemplateType is 4, and the template shape is illustrated in FIG. 2D.

In a case where only the left reference samples and the bottom-left reference samples are available, the value of refTemplateType is 5, and the template shape is illustrated in FIG. 2E.

In a case where only the top reference samples and the top-right reference sample are available, the value of refTemplateType is 6, and the template shape is illustrated in FIG. 2F.

It should be noted that the template may be composed of reconstructed samples within one or more regions of the top side, the top-right side, the left side, the bottom-left side, and the top-left side of the current block. In addition, a size of the template may be preset. For example, in a case where a left template is obtained, a template width templateW_size may be set to 4, and in a case where a top template is obtained, a template height templateH_size may be set to 4.

It should also be noted that the value of refTemplateType may be used for determining to obtain the reconstructed samples of which part. Exemplarily, in a case where the value of refTemplateType is 1, the reconstructed samples on the left side, the top-left side, and the top side of the current block are obtained; alternatively, in a case where the value of refTemplateType is 2, only the reconstructed samples on four columns on the left side of the current block are obtained; alternatively, in a case where the value of refTemplateType is 3, only the reconstructed samples on four rows on the top side of the current block are obtained.

The DM mode is a chroma intra prediction mode in which the chroma depends on the luma. For example, in a case where a chroma block selects the DM mode, the chroma block is to find a luma block at the corresponding position (a method of finding the luma block at the corresponding position is to use a center position of a chroma block to find a luma position corresponding to the chroma block, and a luma block to which the position belongs is the luma block at the corresponding position. For example, in a YUV420 video sequence, coordinates of the center position of the chroma block in a current frame are (x, y), then a luma position corresponding to the chroma block is (2x, 2y), and a luma block corresponding to the chroma block is the luma block to which the position (2x, 2y) belongs). The chroma block directly uses the intra prediction mode of the found luma block, which is a planar mode, a DC mode or an angular prediction mode, which is also referred as a traditional intra prediction mode.

In the ECM, the above IBC technology and the intraTMP technology have no corresponding traditional intra prediction mode, so the corresponding method of the DM mode in an existing situation is described as follows.
1. In a case where the current coding tree unit partitioning is the dual tree: in response to a chroma intra prediction block selecting and using the DM mode and a luma block at the corresponding position using the IBC mode, a DC prediction mode is used for predicting a current chroma block.
2. In a case where the current coding tree unit partitioning is the dual tree: in response to the chroma intra prediction block selecting and using the DM mode and a luma block at the corresponding position using the intraTMP mode, the planar prediction mode is used for predicting a current chroma block.
3. In a case where the current coding tree unit partitioning is the single tree: in response to the chroma intra prediction block selecting and using the DM mode and a luma block at the corresponding position using the intraTMP mode, the planar prediction mode is used for predicting a current chroma block.

It should be noted that in a case where the current coding tree unit partitioning is the single tree, in response to the luma coding unit selecting and using the IBC mode, a chroma block type is also set to an IBC type coding unit, the DM mode is the intra prediction mode, and there is no IBC type coding unit, that is, the IBC type coding unit has no DM mode.

In the ECM, for the case of the dual tree, the intraDBV mode is added to the chroma prediction of the intra coding type.

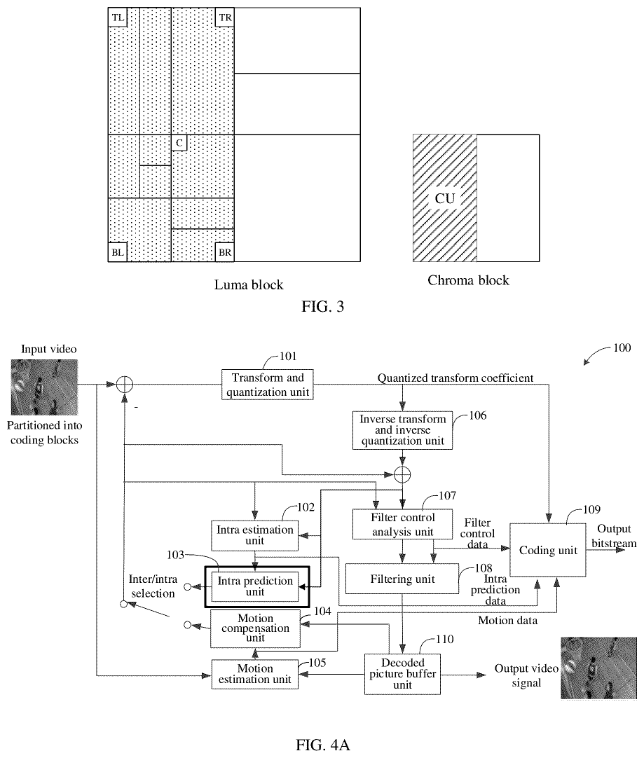

As illustrated in FIG. 3, under the dual tree partitioning, the chroma coding unit finds the corresponding luma region and checks in sequence whether at least one luma block at the following five sample positions (C->TL->TR->BL->BR) uses the IBC mode or the intraTMP mode. In a case where at least one luma block at these five pixel positions uses the IBC or the intraTMP, a first block vector found in sequence is used as a block vector used for chroma block prediction. A reconstructed block at the position pointed to by the chroma block vector is used for predicting the current chroma block.

On the basis of obtaining the prediction value above, weighted prediction with other intra prediction manners may further be implemented, and a result after the weighted prediction is used as a final prediction result.

In chroma prediction, a non-cross-component prediction mode and a cross-component prediction mode are allowed to be weighted to generate the final prediction result, so as to improve the prediction accuracy. A weighting mode in the ECM allows weighting of the DM mode, decoder-side intra mode derivation (DIMD) mode, a traditional intra prediction mode and a cross-component prediction mode. The cross-component model mode used for weighting is classified into three types based on mode types and weighting factors, which is shown in Table 1-2.

TABLE 1-2
Three chroma weighting modes allowed
in the ECM reference software

| A value of a | |
|---|---|
| weighting flag | Weighting Mode |
| 0 | Weighting without using the |
| | cross-component mode |
| 1 | Weighting using the preset weight |
| | and the prediction result obtained |
| | by the multi-models linear mode |
| | (MMLM) cross-component model |
| 2 | Weighting using one set of adaptive |
| | weights and the luma reconstructed |
| | value |
| 3 | Weighting using two sets of |
| | adaptive weights and the luma |
| | reconstructed value |

In addition to the weighting modes in the above ECM, it should also be possible to expand to other cross-component models, as well as weighting modes by using other weights and non-cross-component models.

The embodiments of the present disclosure will be described in detail below with reference to the accompanying drawings.

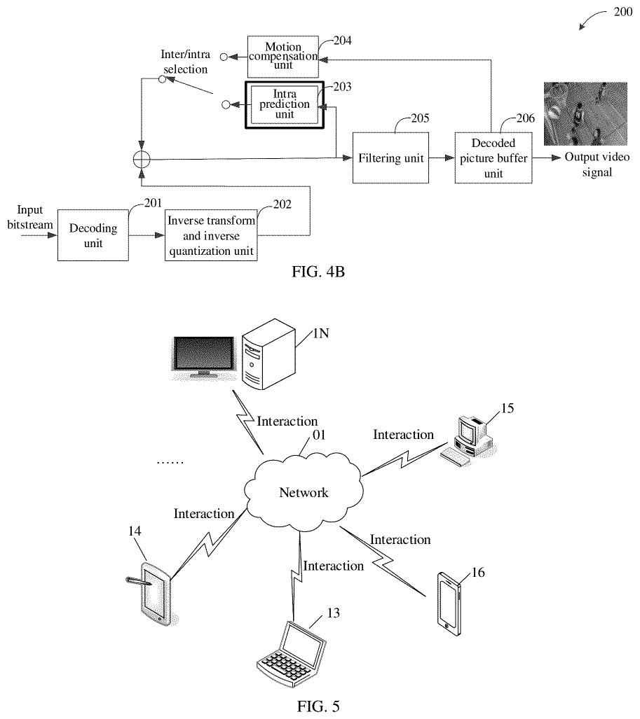

Referring to FIG. 4A, a schematic block diagram of composition of an encoder provided in the embodiments of the present disclosure is illustrated. As illustrated in FIG. 4A, the encoder (a video encoder) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an coding unit 109, and a decoded picture buffer unit 110, or the like, where the filtering unit 108 may implement deblocking filtering and sample adaptive offset (SAO) filtering, and the coding unit 109 may implement header information coding and context-based adaptive binary arithmetic coding (CABAC). For an input original video signal, a video coding block may be obtained by partitioning a coding tree unit (CTU), and then residual sample information obtained after performing intra prediction or inter prediction on the video coding block is transformed by the transform and quantization unit 101, which includes transforming the residual information from a sample domain to a transform domain, and quantizing the obtained transform coefficients to further reduce the bit rate. The intra estimation unit 102 and the intra prediction unit 103 are configured to perform intra prediction on the video coding block. Explicitly speaking, the intra estimation unit 102 and the intra prediction unit 103 are configured to determine an intra prediction mode to be used to encode the video coding block. The motion compensation unit 104 and the motion estimation unit 105 are configured to perform inter prediction coding of a received video coding block relative to one or more blocks in one or more reference pictures to provide time prediction information. The motion estimation performed by the motion estimation unit 105 is a process of generating a motion vector, and the motion vector may estimate the motion of the video coding block, and then the motion compensation unit 104 performs motion compensation based on the motion vector determined by the motion estimation unit 105. After determining the intra prediction mode, the intra prediction unit 103 is further configured to provide selected intra prediction data to the coding unit 109, and the motion estimation unit 105 further transmits the motion vector data determined by calculation to the coding unit 109. In addition, the inverse transform and inverse quantization unit 106 is configured to reconstruct the video coding block, which includes: reconstructing the residual block in the sample domain, and providing the reconstructed residual block to the filter control analysis unit 107 and the filtering unit 108 to remove a blocking effect artifact, and adding the reconstructed residual block to a predictive block in a picture in the decoded picture buffer unit 110, to generate a reconstructed video coding block. The coding unit 109 is configured to code various coding parameters and quantized transform coefficients. In the CABAC-based coding algorithm, context content may be based on neighbouring coding blocks and may be configured to encode information indicating the determined intra prediction mode to output a bitstream of the video signal. The decoded picture buffer unit 110 is configured to store the reconstructed video coding block for prediction reference. As video picture encoding progresses, new reconstructed video coding blocks are continuously generated, and these reconstructed video coding blocks are stored in the decoded picture buffer unit 110.

Referring to FIG. 4B, a schematic block diagram of composition of a decoder provided in embodiments of the present disclosure is illustrated. As illustrated in FIG. 4B, a decoder (a video decoder) 200 includes a decoding unit 201, an inverse transform and inverse quantization unit 202, an intra prediction unit 203, a motion compensation unit 204, a filtering unit 205, and a decoded picture buffer unit 206, or the like, where the decoding unit 201 may implement header information decoding and CABAC decoding, and the filtering unit 205 may implement deblocking filtering and SAO filtering. After the input video signal is encoded in FIG. 4A, a bitstream of the video signal is output; the bitstream is input to the decoder 200, and is processed by the decoding unit 201 first to obtain decoded transform coefficients. The transform coefficients are processed by the inverse transform and inverse quantization unit 202, to generate residual blocks in the sample domain. The intra prediction unit 203 may be configured to generate prediction data for the current video decoding block based on the determined intra prediction mode and the data from a previously decoded block of the current frame or picture. The motion compensation unit 204 is configured to determine the prediction information for the video decoding block by analyzing the motion vector and other associated syntax elements, and generate a predictive block of the video decoding block that is being decoded by using the prediction information. The decoded video block is formed by summing the residual block from the inverse transform and inverse quantization unit 202 and the corresponding prediction block generated by the intra prediction unit 203 or the motion compensation unit 204. The decoded video signal is processed by the filtering unit 205 to remove the blocking effect artifacts, which may improve the quality of the video, and then the decoded video block is stored in the decoded picture buffer unit 206, which stores the reference picture used for subsequent intra prediction or motion compensation, and also used for output of the video signal. That is, the restored original video signal is obtained.

Furthermore, network architecture of an encoding and decoding system including an encoder and a decoder is further provided in the embodiments of the present disclosure, where FIG. 5 illustrates a schematic diagram of network architecture of an encoding and decoding system provided in the embodiments of the present disclosure. As illustrated in FIG. 5, the network architecture includes one or more electronic devices 13 to 1N and a communication network 01, where the electronic devices 13 to 1N may perform video interaction through the communication network 01. During the implementation process, the electronic device may be various types of devices with video encoding and decoding functions, for example, the electronic device may include a smart phone, a pad, a personal computer, a personal digital assistant, a navigator, a digital phone, a video phone, a television, a sensor device, a server, which is not limited here. In addition, the decoder or the encoder described in the embodiments of the present disclosure may be the above electronic device.

It should be noted that the method of the embodiments of the present disclosure is mainly applied to the intra prediction unit 103 part illustrated in FIG. 4A and the intra prediction unit 203 part illustrated in FIG. 4B. That is, the embodiments of the present disclosure may be applied to the encoder, may also be applied to the decoder, and may even be applied to both the encoder and the decoder at the same time, which will not be limited in the embodiments of the present disclosure.

It should also be noted that, in a case where the embodiments of the present disclosure are applied to the intra prediction unit 103, the “current block” refers to a luma encoding block or chroma coding block currently to be intra predicted; in a case where the embodiments of the present disclosure are applied to the intra prediction unit 203, the “current block” refers to a luma decoding block or chroma decoding block currently to be intra predicted.

To facilitate understanding of the technical solutions in the embodiments of the present disclosure, the technical solutions of the present disclosure are described in detail below through embodiments. The above related technologies may be arbitrarily combined with the technical solutions in the embodiments of the present disclosure as optional solutions, and they all fall within the protection scope of the embodiments of the present disclosure. The embodiments of the present disclosure include at least part of the following contents. The present disclosure provides an encoding and decoding method, and more provides an encoding and decoding technology for the intra chroma block.

In a first clause, a decoding method is provided, which is applied to a decoder, and includes:
obtaining prediction mode reference information of a current chroma block;
in a case where the prediction mode reference information meets a usage condition of a first intra prediction mode, decoding a first syntax element flag;
determining, based on the first syntax element flag, whether the current chroma block uses the first intra prediction mode;
in a case where the prediction mode reference information does not meet the usage condition of the first intra prediction mode, decoding a second syntax element flag; and
determining, based on the second syntax element flag, whether the current chroma block uses a second intra prediction mode.

In a second clause, according to the first clause, where the prediction mode reference information includes: intra prediction mode information of a luma block corresponding to the current chroma block; and
the usage condition includes: the luma block corresponding to the current chroma block using a third intra prediction mode.

In a third clause, according to the second clause, where the prediction mode reference information includes: a partitioning mode of a picture unit where the current chroma block is located; and
the usage condition further includes: the partitioning mode of the picture unit where the current chroma block is located being a dual tree structure.

In a fourth clause, according to the second clause, where obtaining the prediction mode reference information of the current chroma block includes:
partitioning, by using a dual tree structure, a luma block and a chroma block in a picture unit where the current chroma block is located, and searching for luma blocks at multiple positions in a first order in a luma region corresponding to the current chroma block;
in a case where a first luma block whose prediction mode is the third intra prediction mode is searched out, determining that the luma block corresponding to the current chroma block uses the third intra prediction mode; and
in a case where no luma block whose prediction mode is the third intra prediction mode is searched out, determining that the luma block corresponding to the current chroma block does not use the third intra prediction mode.

In a fifth clause, according to any one of the first clause to the fourth clause, where the first intra prediction mode is a chroma direct derived block vector prediction mode, and the method further includes:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

In a sixth clause, according to the fifth clause, where determining, based on the block vector of the first luma block, the block vector of the current chroma block includes:
downsampling the block vector of the first luma block, to determine a downsampled block vector; and
performing a fine search based on the downsampled block vector, to determine the block vector of the current chroma block.

In a seventh clause, according to the fifth clause, the method further includes:
in a case of determining that the current chroma block uses the first intra prediction mode, decoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

In an eighth clause, according to any one of the first clause to the fourth clause, where the second intra prediction mode is a chroma direct derived prediction mode, and the method further includes:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

In a ninth clause, according to the eighth clause, the method further includes:
in a case of determining that the current chroma block uses the second intra prediction mode, decoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

In a tenth clause, according to any one of the second clause to the fourth clause, where the third intra prediction mode is an intra block copy prediction mode or an intra template matching prediction mode.

In an eleventh clause, according to the first clause, the method further includes:
in a case of determining, based on the first syntax element flag, that the current chroma block does not use the first intra prediction mode, and determining, based on the second syntax element flag, that the current chroma block does not use the second intra prediction mode, decoding other syntax element flags of the current chroma block; and
determining, based on the other syntax element flags, other intra prediction modes of the current chroma block.

In a twelfth clause, according to the first clause, the method further includes:
decoding a syntax element flag of a cross-component intra prediction mode;
determining, based on the syntax element flag of the cross-component intra prediction mode, that the current chroma block uses the cross-component intra prediction mode, and decoding cross-component intra prediction mode information; and
determining, based on the syntax element flag of the cross-component intra prediction mode, that the current chroma block does not use the cross-component intra prediction mode, and determining whether the prediction mode reference information meets the usage condition of the first intra prediction mode.

In a thirteenth clause, a decoding method is provided, which is applied to a decoder, and includes:
decoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

In a fourteenth clause, according to the thirteenth clause, where the prediction mode reference information includes: intra prediction mode information of a luma block corresponding to the current chroma block; and
the usage condition includes: the luma block corresponding to the current chroma block using a third intra prediction mode.

In a fifteenth clause, according to the fourteenth clause, where the prediction mode reference information includes: a partitioning mode of a picture unit where the current chroma block is located; and
the usage condition further includes: the partitioning mode of the picture unit where the current chroma block is located being a dual tree structure.

In a sixteenth clause, according to the thirteenth clause, where obtaining the prediction mode reference information of the current chroma block includes:
partitioning, by using a dual tree structure, a luma block and a chroma block in a picture unit where the current chroma block is located, and searching for luma blocks at multiple positions in a first order in a luma region corresponding to the current chroma block;
in a case where a first luma block whose prediction mode is a third intra prediction mode is searched out, determining that the luma block corresponding to the current chroma block uses the third intra prediction mode; and
in a case where no luma block whose prediction mode is the third intra prediction mode is searched out, determining that the luma block corresponding to the current chroma block does not use the third intra prediction mode.

In a seventeenth clause, according to any one of the thirteenth clause to the sixteenth clause, where the first intra prediction mode is a chroma direct derived block vector prediction mode, and the method further includes:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

In an eighteenth clause, according to the seventeenth clause, where determining, based on the block vector of the first luma block, the block vector of the current chroma block includes:
downsampling the block vector of the first luma block, to determine a downsampled block vector; and
performing a fine search based on the downsampled block vector, to determine the block vector of the current chroma block.

In a nineteenth clause, according to any one of the thirteenth clause to the sixteenth clause, where the second intra prediction mode is a chroma direct derived prediction mode, and the method further includes:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

In a twentieth clause, according to any one of the thirteenth clause to the nineteenth clause, the method further includes:
in the case of determining, based on the third syntax element flag, that the current chroma block is allowed to use the first intra prediction mode and the second intra prediction mode, decoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on a first prediction block and the second prediction block, to obtain a final prediction block of the current chroma block.

In a twenty-first clause, according to any one of the fourteenth clause to the sixteenth clause, where the third intra prediction mode is an intra block copy prediction mode or an intra template matching prediction mode.

In a twenty-second clause, according to the thirteenth clause, the method further includes:
in a case of determining, based on the third syntax element flag, that the current chroma block is not allowed to use the first intra prediction mode and the second intra prediction mode, decoding other syntax element flags of the current chroma block; and
determining, based on the other syntax element flags, other intra prediction modes of the current chroma block.

In a twenty-third clause, according to the thirteenth clause, the method further includes:
decoding a syntax element flag of a cross-component intra prediction mode;
determining, based on the syntax element flag of the cross-component intra prediction mode, that the current chroma block uses the cross-component intra prediction mode, and decoding cross-component intra prediction mode information; and
determining, based on the syntax element flag of the cross-component intra prediction mode, that the current chroma block does not use the cross-component intra prediction mode, and decoding the third syntax element flag.

In a twenty-fourth clause, an encoding method is provided, which is applied to an encoder and includes:
obtaining prediction mode reference information of a current chroma block;
in a case where the prediction mode reference information meets a usage condition of a first intra prediction mode, encoding a first syntax element flag;
determining, based on the first syntax element flag, whether the current chroma block uses the first intra prediction mode;
in a case where the prediction mode reference information does not meet the usage condition of the first intra prediction mode, encoding a second syntax element flag; and
determining, based on the second syntax element flag, whether the current chroma block uses a second intra prediction mode.

In a twenty-fifth clause, according to the twenty-fourth clause, where the prediction mode reference information includes: intra prediction mode information of a luma block corresponding to the current chroma block; and
the usage condition includes: the luma block corresponding to the current chroma block using a third intra prediction mode.

In a twenty-sixth clause, according to the twenty-fifth clause, where the prediction mode reference information includes: a partitioning mode of a picture unit where the current chroma block is located; and
the usage condition further includes: the partitioning mode of the picture unit where the current chroma block is located being a dual tree structure.

In a twenty-seventh clause, according to any one of the twenty-fourth clause to the twenty-sixth clause, where the first intra prediction mode is a chroma direct derived block vector prediction mode, and the method further includes:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

In a twenty-eighth clause, according to the twenty-seventh clause, where determining, based on the block vector of the first luma block, the block vector of the current chroma block includes:
downsampling the block vector of the first luma block, to determine a downsampled block vector; and
performing a fine search based on the downsampled block vector, to determine the block vector of the current chroma block.

In a twenty-ninth clause, according to the twenty-seventh clause, the method further includes:
in a case of determining that the current chroma block uses the first intra prediction mode, encoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

In a thirtieth clause, according to any one of the twenty-fourth clause to the twenty-sixth clause, where the second intra prediction mode is a chroma direct derived prediction mode, and the method further includes:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

In a thirty-first clause, according to the thirtieth clause, the method further includes:
in a case of determining that the current chroma block uses the second intra prediction mode, encoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

In a thirty-second clause, according to the twenty-fifth clause, where the third intra prediction mode is an intra block copy prediction mode or an intra template matching prediction mode.

In a thirty-third clause, according to the twenty-fourth clause, the method further includes:
in a case of determining, based on the first syntax element flag, that the current chroma block does not use the first intra prediction mode, and determining, based on the second syntax element flag, that the current chroma block does not use the second intra prediction mode, encoding other syntax element flags of the current chroma block; and
determining, based on the other syntax element flags, other intra prediction modes of the current chroma block.

In a thirty-fourth clause, according to the twenty-fourth clause, the method further includes:
encoding a syntax element flag of a cross-component intra prediction mode;
determining, based on the syntax element flag of the cross-component intra prediction mode, that the current chroma block uses the cross-component intra prediction mode, and encoding cross-component intra prediction mode information; and
determining, based on the syntax element flag of the cross-component intra prediction mode, that the current chroma block does not use the cross-component intra prediction mode, and determining whether the prediction mode reference information meets the usage condition of the first intra prediction mode.

In a thirty-fifth clause, an encoding method is provided, which is applied to an encoder and includes:
encoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

In a thirty-sixth clause, according to the thirty-fifth clause, where the prediction mode reference information includes: intra prediction mode information of a luma block corresponding to the current chroma block; and
the usage condition includes: the luma block corresponding to the current chroma block using a third intra prediction mode.

In a thirty-seventh clause, according to the thirty-sixth clause, where the prediction mode reference information includes: a partitioning mode of a picture unit where the current chroma block is located; and
the usage condition further includes: the partitioning mode of the picture unit where the current chroma block is located being a dual tree structure.

In a thirty-eighth clause, according to any one of the thirty-fifth clause or the thirty-seventh clause, where the first intra prediction mode is a chroma direct derived block vector prediction mode, and the method further includes:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

In a thirty-ninth clause, according to the thirty-eighth clause, where determining, based on the block vector of the first luma block, the block vector of the current chroma block includes:
downsampling the block vector of the first luma block, to determine a downsampled block vector; and
performing a fine search based on the downsampled block vector, to determine the block vector of the current chroma block.

In a fortieth clause, according to any one of the thirty-fifth clause or the thirty-seventh clause, where the second intra prediction mode is a chroma direct derived prediction mode, and the method further includes:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

In a forty-first clause, according to any one of the thirty-fifth clause or the fortieth clause, the method further includes:
in a case of determining, based on the third syntax element flag, that the current chroma block is allowed to use the first intra prediction mode and the second intra prediction mode, encoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on a first prediction block and the second prediction block, to obtain a final prediction block of the current chroma block.

In a forty-second clause, according to the thirty-sixth clause, where the third intra prediction mode is an intra block copy prediction mode or an intra template matching prediction mode.

In a forty-third clause, according to the thirty-fifth clause, the method further includes:
in a case of determining, based on the third syntax element flag, that the current chroma block is not allowed to use the first intra prediction mode and the second intra prediction mode, encoding other syntax element flags of the current chroma block; and
determining, based on the other syntax element flags, other intra prediction modes of the current chroma block.

In a forty-fourth clause, according to the thirty-fifth clause, the method further includes:
encoding a syntax element flag of a cross-component intra prediction mode;
determining, based on the syntax element flag of the cross-component intra prediction mode, that the current chroma block uses the cross-component intra prediction mode, and encoding cross-component intra prediction mode information; and
determining, based on the syntax element flag of the cross-component intra prediction mode, that the current chroma block does not use the cross-component intra prediction mode, and encoding the third syntax element flag.

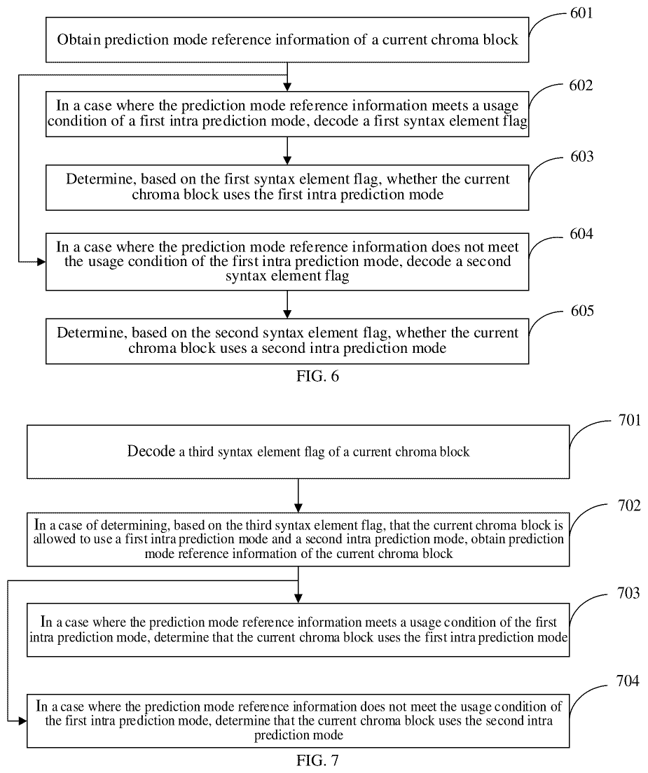

In an embodiment of the present disclosure, referring to FIG. 6, a schematic flowchart of a decoding method provided in the embodiments of the present disclosure is illustrated. As illustrated in FIG. 6, the method may include following operations.

In operation 601, prediction mode reference information of a current chroma block is obtained.

It should be noted that the prediction mode reference information is used for determining an intra prediction mode of the current chroma block.

In some embodiments, the prediction mode reference information includes relevant information of a luma block corresponding to the current chroma block. Exemplarily, the prediction mode reference information may be intra prediction mode information of the luma block corresponding to the current chroma block.

In some embodiments, the prediction mode reference information may further include a partitioning mode of a picture unit where the current chroma block is located. Exemplarily, the picture unit where the current chroma block is located may be a current coding tree unit (CTU), or may be a current frame or other coding units. The partitioning mode is used for indicating the partitioning tree structure used for the luma block and the chroma block when coding an intra-frame. The partitioning tree structure may be a single tree structure or a dual tree structure.

In some embodiments, obtaining the prediction mode reference information of the current chroma block includes: partitioning, by using a single tree structure, a luma block and a chroma block in a picture unit where the current chroma block is located, and obtaining a prediction mode of a first luma block corresponding to the current chroma block; in a case where the prediction mode of the first luma block is a third intra prediction mode, determining that the luma block corresponding to the current chroma block uses the third intra prediction mode; in a case where the prediction mode of the first luma block is not the third intra prediction mode, determining that the luma block corresponding to the current chroma block does not use the third intra prediction mode.

In some embodiments, obtaining the prediction mode reference information of the current chroma block includes: partitioning, by using a dual tree structure, a luma block and a chroma block in a picture unit where the current chroma block is located, and searching for luma blocks at multiple positions in a first order in a luma region corresponding to the current chroma block; in a case where a first luma block whose prediction mode is the third intra prediction mode is searched out, determining that the luma block corresponding to the current chroma block uses the third intra prediction mode; and in a case where no luma block whose prediction mode is the third intra prediction mode is searched out, determining that the luma block corresponding to the current chroma block does not use the third intra prediction mode.

In some embodiments, the prediction mode reference information may further include a size of the current chroma block and relevant syntax elements of the current chroma block.

In operation 602, in a case where the prediction mode reference information meets a usage condition of the first intra prediction mode, a first syntax element flag is decoded.

It should be noted that the usage condition of the first intra prediction mode is used for determining whether the current chroma block is capable of using the first intra prediction mode. Exemplarily, the first intra prediction mode may be any chroma intra prediction mode. For example, the first intra prediction mode may be a chroma direct derived block vector prediction mode (i.e., the intraDBV mode) or a chroma direct derived prediction mode (i.e., the DM mode).

In some embodiments, in a case where the intra prediction mode information of the luma block corresponding to the current chroma block, the usage condition may include: the luma block corresponding to the current chroma block using a third intra prediction mode. That is, in a case where the intra prediction mode of the luma block corresponding to the current chroma block is the third intra prediction mode, it is determined that the current chroma block is capable of using the first intra prediction mode; otherwise, it is determined that the current chroma block cannot use the first intra prediction mode.

Exemplarily, the first intra prediction mode is the intraDBV mode, and the third intra prediction mode may be the IBC mode or the intraTMP mode.

Exemplarily, the first intra prediction mode is the DM mode, and the third intra prediction mode may be a traditional intra prediction mode, such as the planar mode, the DC mode, or the angular prediction mode.

In some embodiments, the prediction mode reference information includes: the partitioning mode of the picture unit where the current chroma block is located; and the usage condition further includes: the partitioning mode of the picture unit where the current chroma block is located being a dual tree structure.

In some embodiments, the prediction mode reference information includes: the partitioning mode of the picture unit where the current chroma block is located; and the usage condition further includes: the partitioning mode of the picture unit where the current chroma block is located is being a single tree structure.

It should be noted that in a case where the prediction mode reference information does not include the partitioning mode of the picture unit where the current chroma block is located, the usage condition does not limit the partitioning mode, that is, the first intra prediction mode is applicable to any partitioning mode.

In operation 603, it is determined, based on the first syntax element flag, whether the current chroma block uses the first intra prediction mode.

It should be noted that the first syntax element flag is used for indicating whether the current chroma block uses the first intra prediction mode. Exemplarily, in a case where the first syntax element flag is a first value, it is determined that the current chroma block does not use the first intra prediction mode; in a case where the first syntax element flag is a second value, it is determined that the current chroma block uses the first intra prediction mode.

Furthermore, in some embodiments, the first intra prediction mode is the chroma direct derived block vector prediction mode (i.e., the intraDBV), and the method further includes: in a case of determining that the current chroma block uses the first intra prediction mode, obtaining a block vector of a first luma block corresponding to the current chroma block; determining, based on the block vector of the first luma block, a block vector of the current chroma block; and determining, based on the block vector of the current chroma block, a first prediction block of the current chroma block.

Exemplarily, in a case where the current chroma block is predicted by using the intraDBV, as illustrated in FIG. 3, under the dual tree partitioning, the chroma block finds a corresponding luma region, and checks whether there is at least one of luma blocks at the following five positions (C->TL->TR->BL->BR) in a first order using the IBC mode or the intraTMP mode. In a case where the at least one of luma blocks at these five positions uses the IBC or the intraTMP, the first block vector found in the first order (C->TL->TR->BL->BR) is used for deriving a chroma block vector, and a reconstructed block at the position pointed to by the chroma block vector is used for predicting the current chroma block.

In some implementations, determining, based on the block vector of the first luma block, the block vector of the current chroma block includes: downsampling the block vector of the first luma block, to determine a downsampled block vector; and performing a fine search based on the downsampled block vector, to determine the block vector of the current chroma block. Exemplarily, a fine search based on template matching is performed based on the downsampled block vector, to determine the best block vector for the current chroma block.

It should be noted that, in a case of determining that the current chroma block uses the first intra prediction mode, other syntax elements related to the first intra prediction mode may further be decoded, to further determine other sub-modes of the current chroma block.

In some embodiments, the method further includes: in a case of determining that the current chroma block uses the first intra prediction mode, decoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or a type of the weighted prediction mode in a case where the weighted prediction mode is used.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In operation 604, in a case where the prediction mode reference information does not meet the usage condition of the first intra prediction mode, a second syntax element flag is decoded.

In operation 605, it is determined, based on the second syntax element flag, whether the current chroma block uses the second intra prediction mode.

It should be noted that the second syntax element flag is used for indicating whether the current chroma block uses the second intra prediction mode. Exemplarily, in a case where the second syntax element flag is a first value, it is determined that the current chroma block does not use the second intra prediction mode; in a case where the second syntax element flag is a second value, it is determined that the current chroma block uses the second intra prediction mode.

Furthermore, in some embodiments, the second intra prediction mode is the chroma direct derived prediction mode (i.e., the DM), and the method further includes: in a case of determining that the current chroma block uses the second intra prediction mode, obtaining an intra prediction mode of a luma block corresponding to the current chroma block; taking the intra prediction mode of the luma block as the intra prediction mode of the current chroma block; and determining, based on the intra prediction mode of the current chroma block, a first prediction block of the current chroma block.

It should be noted that in a case of determining that the current chroma block uses the DM mode, the luma block corresponding to the current chroma block does not use the third intra prediction mode, that is, there is no available BV for the luma block corresponding to the current chroma block, and the intra prediction mode of the luma block may be directly used as the intra prediction mode of the current chroma block. These modes may be the traditional intra prediction modes, such as the planar mode, the DC mode, or the angular prediction mode.

It should be noted that, in a case of determining that the current chroma block uses the second intra prediction mode, other syntax elements related to the second intra prediction mode may further be decoded, to further determine other sub-modes of the current chroma block.

In some embodiments, the method further includes: in a case of determining that the current chroma block uses the second intra prediction mode, decoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or the type of the weighted prediction mode in a case of using the weighted prediction mode; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In some embodiments, the method further includes: decoding a syntax element flag of a cross-component intra prediction mode; determining, based on the syntax element flag of the cross-component intra prediction mode, that the current chroma block uses the cross-component intra prediction mode, and decoding cross-component intra prediction mode information; and determining, based on the syntax element flag of the cross-component intra prediction mode, that the current chroma block does not use the cross-component intra prediction mode, and determining whether the prediction mode reference information meets the usage condition of the first intra prediction mode.

That is, before decoding the first syntax element flag and the second syntax element flag, the syntax element flag of the cross-component intra prediction mode of the current chroma block is decoded first, and it is first determined, based on the syntax element flag, whether the current chroma block uses the cross-component intra prediction mode. If the current chroma block does not use the cross-component intra prediction mode, it is further determined, based on the prediction mode reference information, whether to decode the first syntax element flag or the second syntax element flag.

In some embodiments, the method further includes: in a case where the prediction mode reference information meets a usage condition of the first intra prediction mode, determining that the second syntax element flag is a preset value for indicating that the current chroma block does not use the second intra prediction mode; and in a case where the prediction mode reference information does not meet the usage condition of the first intra prediction mode, determining that the first syntax element flag is a preset value for indicating that the current chroma block does not use the first intra prediction mode.

In some embodiments, the method may further include: in a case of determining, based on the first syntax element flag, that the current chroma block does not use the first intra prediction mode, and determining, based on the second syntax element flag, that the current chroma block does not use the second intra prediction mode, decoding other syntax element flags of the current chroma block; and determining, based on the other syntax element flags, other intra prediction modes of the current chroma block.

That is, in a case where the intra prediction mode of the current chroma block cannot be determined based on the first syntax element flag and the second syntax element flag, other intra prediction modes are further decoded. Exemplarily, other intra prediction modes may be the DIMD mode, the planar mode, the DC mode or the angular prediction mode.

For example, the description of the relevant syntax elements of an intra coded chroma coding unit is shown in Table 2-1.

TABLE 2-1

| | |
|---|---|
| intra_chroma_pred_mode( ){ // encode and decode a | |
| chroma intra prediction mode | |
| if( getUseLMChroma( ) ) // if a cross-component | |
| prediction mode is allowed | |
| isLMCMode // encode and decode a cross-component | ae(v) |
| enable flag | |
| if( isLMCMode ) { | |
| ........ // further encode and decode a cross-component | |
| prediction sub-mode | |
| } else { // if it is not a cross-component prediction | |
| if (dual_tree && (luma ==IBC \|\| luma ==intraTMP)){ // if | |
| there is BV at the five positions corresponding to the luma and in | |
| case of dual tree | |
| DBVFlag // encode and decode a DBV enable flag | ae(v) |
| if (DBVFlag) { // if it is a DBV mode | |
| ... ... // encode and decode other sub-modes, such as a | |
| mode with cross-component model prediction weighting | |
| } | |
| } | |
| else{ // if a condition for allowing a usage condition of | |
| the intraDBV is not met | |
| DMFlag //encode and decode a DM mode enable flag | ae(v) |
| if (DMFlag){ // if it is a DM mode | |
| ... ... // encode and decode other sub-modes, such as the mode | |
| with cross-component model prediction weighting | |
| } | |
| } | |
| if(!DMFlag && !DBVFlag){ // if it is not the DM mode | |
| and not the DBV mode | |
| ....... // then encode and decode other chroma prediction | |
| modes | |
| } | |
| } // else | |
| } // intra_chroma_pred_mode( ) | |

It should be noted that the usage condition for the intraDBV mode in Table 2-1 is as follows.
1. Partitioning of the current frame is dual tree (dual tree is only allowed to be enabled in the intra-coded frame).
2. There is at least one of luma blocks at five positions that has an available BV in a luma region corresponding to chroma block. That is, at least one luma block uses the intraTMP mode or the IBC mode.

In a case where the usage condition for the intraDBV mode is met, the DM mode is skipped. In a case where the usage condition for the intraDBV mode is not met, the intraDBV mode is skipped. That is, the intraDBV mode is used for the chroma block that can use the intraDBV mode, and other intra prediction modes are used for the chroma block that cannot use the intraDBV mode.

In the ECM reference software, for the intra coded chroma coding unit, intra prediction modes used in a case of predicting the chroma coding unit need to be encoded and decoded in a certain order. An encoding and decoding order of these modes may be as follows.
1. In response to the cross-component prediction mode being allowed to use, the cross-component intra prediction mode that uses the luma to predict chroma is decoded.
2. In response to the cross-component prediction mode being not used, it is determined whether the usage condition for the intraDBV mode is met. In response to the usage condition for the intraDBV mode being met, the DBV flag (corresponding to the first syntax element flag) is decoded. In response to DBV flag=1, it is determined that the DBV mode is used, that is, a chroma BV is determined by using a BV found in a luma region corresponding to the current chroma coding, to predict a chroma mode.
3. In response to the usage condition for the intraDBV mode being not met, the DMflag (corresponding to the second syntax element flag) is decoded. In response to DMflag=1, it is determined that the DM mode is used, and the chroma coding unit is predicted by using a traditional intra mode selected by the luma coding unit corresponding to the current chroma coding unit.
4. In response to the mode being neither DM mode nor the DBV mode, the DIMD mode is decoded. The decoder analyzes a gradient of a reconstructed part by using the reconstructed part around the current block, converts the gradient into an angle in an angle mode, and uses the angle mode to predict the current block.
5. None of the above intra prediction modes are used, other traditional prediction modes are decoded, which includes those not used in 2 to 4 above.

For example, the description of the relevant syntax elements of an intra coded chroma coding unit is shown in Table 2-2.

TABLE 2-2

| | |
|---|---|
| intra_chroma_pred_mode( ){ // encode and decode a | |
| chroma intra prediction mode | |
| if( getUseLMChroma( ) ) // if a cross-component | |
| prediction mode is allowed | |
| isLMCMode // encode and decode a cross-component | ae(v) |
| enable flag | |
| if( isLMCMode ) { /* LM chroma mode */ | |
| ........ // further encode and decode a cross-component | |
| prediction sub-mode | |
| } else { // if it is not a cross-component prediction | |
| if ( (luma ==IBC \|\| luma ==intraTMP)){ // if a | |
| corresponding luma block has a BV | |
| DBVFlag //encode and decode a DBV enable flag | ae(v) |
| if (DBVFlag) { // if it is a DBV mode | |
| ... ... // encode and decode other sub-modes, such as a | |
| mode with cross-component model prediction weighting | |
| } | |
| } | |
| else{ //if a condition for allowing the intraDBV is not met | |
| DMFlag //encode and decode a DM mode enable flag | ae(v) |
| if (DMFlag){ // if it is a DM mode | |
| ... ... // encode and decode other sub-modes, such as the mode | |
| with cross-component model prediction weighting | |
| } | |
| } | |
| if(!DMFlag && !DBVFlag){ // if it is not the DM mode | |
| and the DBV mode | |
| ....... // then encode and decode other chroma prediction | |
| modes | |
| } | |
| } // else | |
| } // intra_chroma_pred_mode( ) | |

It should be noted that the usage condition for the intraDBV mode in Table 2-2 is as follows.
1. At least one luma block corresponding to the chroma block has an available BV, that is, the luma block uses the intraTMP mode or the IBC mode.

That is, the usage condition of the intraDBV mode does not limit a partitioning tree structure. In a case where the partitioning tree is a single tree, each partitioned luma block and chroma block has a one-to-one correspondence, and there will not be a situation where multiple luma blocks exist in a region corresponding to one chroma block. Under the single tree, in a case where the luma block selects the IBC mode or the intraTMP, the chroma block uses the intraDBV mode, so that the chroma may be predicted by deriving a chroma block vector by using a block vector found by the luma. Under the dual tree, in a case where at least one of luma blocks in five positions of the chroma block corresponding to a luma region selects the IBC mode or the intraTMP, the chroma block uses the intraDBV mode, so that the chroma may be predicted by deriving the chroma block vector by using the block vector found by the luma.

In another embodiment of the present disclosure, referring to FIG. 7, a schematic flowchart of another decoding method provided in the embodiments of the present disclosure is illustrated. As illustrated in FIG. 7, the method may include following operations.

In operation 701, a third syntax element flag of a current chroma block is decoded.

It should be noted that the third syntax element flag is used to indicate whether a first intra prediction mode and a second intra prediction mode are allowed to be used. That is, in the embodiments of the present disclosure, a syntax element flag may be used to simultaneously indicate that the first intra prediction mode and the second intra prediction mode are used, or indicate that the first intra prediction mode and the second intra prediction mode are not used.

Exemplarily, in a case where the third syntax element flag is a first value, it is determined that the current chroma block does not use the first intra prediction mode and the second intra prediction mode; and in a case where the third syntax element flag is a second value, it is determined that the current chroma block uses the first intra prediction mode and the second intra prediction mode.

Exemplarily, the third syntax element may be an existing syntax element, that is, a usage situation of the first intra prediction mode and the second intra prediction mode is indicated by extending meaning of the existing syntax element. For example, the third syntax element flag may be a DM flag used for enabling the DM mode.

Exemplarily, the third syntax element may also be a newly added syntax element.

In a case where the third syntax element indicates that the first intra prediction mode and the second intra prediction mode are allowed to be used, it is determined whether the prediction mode reference information meets a usage condition of the first intra prediction mode. In a case where the prediction mode reference information meets the usage condition of the first intra prediction mode, it may be directly determined that the current chroma block uses the first intra prediction mode. In a case where the prediction mode reference information does not meet the usage condition of the first intra prediction mode, it is determined that the current chroma block uses the second intra prediction mode. In this way, in a case of encoding and decoding a chroma component, the third syntax element flag is used for enabling these two intra prediction modes, thereby reducing encoding and decoding bits.

In operation 702, in a case of determining, based on the third syntax element flag, that the current chroma block is allowed to use a first intra prediction mode and a second intra prediction mode, prediction mode reference information of the current chroma block is obtained.

It should be noted that the prediction mode reference information is used for determining an intra prediction mode of the current chroma block.

In some embodiments, the prediction mode reference information includes relevant information of a luma block corresponding to the current chroma block. Exemplarily, the prediction mode reference information may be intra prediction mode information of the luma block corresponding to the current chroma block.

In some embodiments, the prediction mode reference information may further include a partitioning mode of a picture unit where the current chroma block is located. Exemplarily, the picture unit where the current chroma block is located may be a current coding tree unit (CTU), or may be a current frame or other coding units. The partitioning mode is used for indicating the partitioning tree structure used for the luma block and the chroma block when coding an intra-frame. The partitioning tree structure may be a single tree structure or a dual tree structure.

In some embodiments, obtaining the prediction mode reference information of the current chroma block includes: partitioning, by using a single tree structure, a luma block and a chroma block in a picture unit where the current chroma block is located, and obtaining a prediction mode of a first luma block corresponding to the current chroma block; in a case where the prediction mode of the first luma block is a third intra prediction mode, determining that the luma block corresponding to the current chroma block uses the third intra prediction mode; in a case where the prediction mode of the first luma block is not the third intra prediction mode, determining that the luma block corresponding to the current chroma block does not use the third intra prediction mode.

In some embodiments, obtaining the prediction mode reference information of the current chroma block includes: partitioning, by using a dual tree structure, a luma block and a chroma block in a picture unit where the current chroma block is located, and searching for luma blocks at multiple positions in a first order in a luma region corresponding to the current chroma block; in a case where a first luma block whose prediction mode is the third intra prediction mode is searched out, determining that the luma block corresponding to the current chroma block uses the third intra prediction mode; and in a case where no luma block whose prediction mode is the third intra prediction mode is searched out, determining that the luma block corresponding to the current chroma block does not use the third intra prediction mode.

In some embodiments, the prediction mode reference information may further include a size of the current chroma block and relevant syntax elements of the current chroma block.

In operation 703, in a case where the prediction mode reference information meets a usage condition of the first intra prediction mode, it is determined that the current chroma block uses the first intra prediction mode.

It should be noted that the usage condition of the first intra prediction mode is used for determining whether the current chroma block is capable of using the first intra prediction mode. Exemplarily, the first intra prediction mode may be any chroma intra prediction mode. For example, the first intra prediction mode may be a chroma direct derived block vector prediction mode (i.e., the intraDBV mode) or a chroma direct derived prediction mode (i.e., the DM mode).

In some embodiments, in a case where the prediction mode reference information includes the intra prediction mode information of the luma block corresponding to the current chroma block, the usage condition may include: the luma block corresponding to the current chroma block using a third intra prediction mode. That is, in a case where the intra prediction mode of the luma block corresponding to the current chroma block is the third intra prediction mode, it is determined that the current chroma block is capable of using the first intra prediction mode; otherwise, it is determined that the current chroma block cannot use the first intra prediction mode.

Exemplarily, the first intra prediction mode is the intraDBV mode, and the third intra prediction mode may be the IBC mode or the intraTMP mode.

Exemplarily, the first intra prediction mode is the DM mode, and the third intra prediction mode may be a traditional intra prediction mode, such as the planar mode, the DC mode, or the angular prediction mode.

In some embodiments, the prediction mode reference information includes: the partitioning mode of the picture unit where the current chroma block is located; and the usage condition further includes: the partitioning mode of the picture unit where the current chroma block is located bring a dual tree structure.

In some embodiments, the prediction mode reference information includes: the partitioning mode of the picture unit where the current chroma block is located; and the usage condition further includes: the partitioning mode of the picture unit where the current chroma block is located being a single tree structure.

It should be noted that in a case where the prediction mode reference information does not include the partitioning mode of the picture unit where the current chroma block is located, the usage condition does not limit the partitioning mode, that is, the first intra prediction mode is applicable to any partitioning mode.

Furthermore, in some embodiments, the first intra prediction mode is the chroma direct derived block vector prediction mode (i.e., the intraDBV), and the method further includes: in a case of determining that the current chroma block uses the first intra prediction mode, obtaining a block vector of a first luma block corresponding to the current chroma block; determining, based on the block vector of the first luma block, a block vector of the current chroma block; and determining, based on the block vector of the current chroma block, a first prediction block of the current chroma block.

Exemplarily, in a case where the current chroma block is predicted by using the intraDBV, as illustrated in FIG. 3, under the dual tree partitioning, the chroma block finds a corresponding luma region, and checks whether there is at least one of luma blocks at the following five positions (C->TL->TR->BL->BR) in a first order using the IBC mode or the intraTMP mode. In a case where the at least one of luma blocks at these five positions uses the IBC or the intraTMP, the first block vector found in the first order (C->TL->TR->BL->BR) is used for deriving a chroma block vector, and a reconstructed block at the position pointed to by the chroma block vector is used for predicting the current chroma block.

In some implementations, determining, based on the block vector of the first luma block, the block vector of the current chroma block includes: downsampling the block vector of the first luma block, to determine a downsampled block vector; and performing a fine search based on the downsampled block vector, to determine the block vector of the current chroma block. Exemplarily, a fine search based on template matching is performed based on the downsampled block vector, to determine the best block vector for the current chroma block.

It should be noted that, in a case of determining that the current chroma block uses the first intra prediction mode, other syntax elements related to the first intra prediction mode may further be decoded, to further determine other sub-modes of the current chroma block.

In some embodiments, the method further includes: in a case of determining that the current chroma block uses the first intra prediction mode, decoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or a type of the weighted prediction mode in a case where the weighted prediction mode is used; where the type of the weighted prediction mode is used for indicating a weighting factor and the fourth intra prediction mode.

In some embodiments, the type of the weighted prediction mode is used for indicating the weighting factor and the fourth intra prediction mode. Exemplarily, the type of the weighted prediction modes may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In operation 704, in a case where the prediction mode reference information does not meet the usage condition of the first intra prediction mode, it is determined that the current chroma block uses the second intra prediction mode.

Furthermore, in some embodiments, the second intra prediction mode is the chroma direct derived prediction mode (i.e., the DM), and the method further includes: in a case of determining that the current chroma block uses the second intra prediction mode, obtaining an intra prediction mode of a luma block corresponding to the current chroma block; taking the intra prediction mode of the luma block as the intra prediction mode of the current chroma block; and determining, based on the intra prediction mode of the current chroma block, a first prediction block of the current chroma block. These modes may be traditional intra prediction modes, such as the planar mode, the DC mode, or the angular prediction mode.

It should be noted that, in a case of determining that the current chroma block uses the second intra prediction mode, other syntax elements related to the second intra prediction mode may further be decoded, to further determine other sub-modes of the current chroma block.

In some embodiments, the method further includes: in a case of determining that the current chroma block uses the second intra prediction mode, decoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or the type of the weighted prediction mode in a case of using the weighted prediction mode; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include:

weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In some embodiments, the method further includes: decoding a syntax element flag of a cross-component intra prediction mode; determining, based on the syntax element flag of the cross-component intra prediction mode, that the current chroma block uses the cross-component intra prediction mode, and decoding the cross-component intra prediction mode information; and determining, based on the syntax element flag of the cross-component intra prediction mode, that the current chroma block does not use the cross-component intra prediction mode, and decoding a third syntax element flag.

That is, before decoding the third syntax element flag, the syntax element flag of the cross-component intra prediction mode of the current chroma block is decoded first, and it is first determined, based on the syntax element flag, whether the current chroma block uses the cross-component intra prediction mode. If the current chroma block does not use the cross-component intra prediction mode, the third syntax element flag is further decoded.

In some embodiments, the method further includes: determining, based on the syntax element flag of the cross-component intra prediction mode, that the current chroma block uses the cross-component intra prediction mode, and determining that the third syntax element flag is a preset value for indicating that the current chroma block does not use the first intra prediction mode and the second intra prediction mode.

In some embodiments, the method may further include: in a case of determining, based on the third syntax element flag, that the current chroma block is not allowed to use the first intra prediction mode and the second intra prediction mode, decoding other syntax element flags of the current chroma block, and determining, based on the other syntax element flags, other intra prediction modes of the current chroma block.

That is, in a case of determining, based on the third syntax element flag, that the current chroma block does not use the first intra prediction mode and the second intra prediction mode, other intra prediction modes are further decoded. Exemplarily, the other intra prediction modes may be the DIMD mode, the planar mode, the DC mode or the angular prediction mode.

For example, the description of the relevant syntax elements of an intra coded chroma coding unit is shown in Table 2-3.

TABLE 2-3

| | |
|---|---|
| intra_chroma_pred_mode( ){ // encode and decode a chroma | |
| intra prediction mode | |
| if( getUseLMChroma( ) ) // If a cross-component prediction | |
| mode is allowed | |
| isLMCMode // encode and decode a cross-component | ae(v) |
| enable flag | |
| if( isLMCMode ) { | |
| ........ // further encode and decode a cross-component | |
| prediction sub-mode | |
| } else { // if it is not a cross-component prediction | |
| DMFlag //encode and decode a DM mode enable flag | ae(v) |
| if (DMFlag){ // if it is a DM mode | |
| ... ... // encode and decode other sub-modes, such as a | |
| mode with cross-component model prediction | |
| weighting | |
| } | |
| if(!DMFlag){ // if it is not the DM mode | |
| ....... // then encode and decode other chroma prediction | |
| modes | |
| } | |
| } // else | |
| } // intra_chroma_pred_mode( ) | |

In the ECM reference software, for the intra coded chroma coding unit, intra prediction modes used in a case of predicting the chroma coding units need to be encoded and decoded in a certain order. An encoding and decoding order of these modes may be as follows.
1. In response to the cross-component prediction mode being allowed to use, the cross-component intra prediction mode that uses the luma to predict chroma is decoded.
2. In response to the cross-component prediction mode being not used, the DMflag is decoded (corresponding to the third syntax element flag). In response to DMflag=1, it is determined that the DM mode is used, and determined whether the usage condition for the intraDBV mode is met. In response to the usage condition for the intraDBV mode being met, it is determined to use the DBV mode, that is, a chroma BV is determined by using a BV found in a luma region corresponding to the current chroma coding, to predict a chroma mode.
3. In response to the usage condition for the intraDBV mode being not met, it is determined that the DM mode is used, and the chroma coding unit is predicted by using a traditional intra mode selected by the luma coding unit corresponding to the current chroma coding unit.

In some implementations, in response to the current frame using dual tree partitioning, and there is more than or equal to one usable block vector in the five positions of the luma region corresponding to the chroma block, then the block vector will be downsampled and optimized with sub-sample accuracy for prediction of the current chroma block.

In response to the current frame using single tree partitioning, and the luma block corresponding to the current chroma block is predicted by using the intraTMP mode, the block vector found by intraTMP will be downsampled and optimized with sub-sample accuracy for prediction of the current chroma block.

In response to there being no block vector available for the luma at the position corresponding to the current chroma block (i.e., under the dual tree, there is no block using the IBC mode or the intraTMP mode in the luma region, or in the single tree, the corresponding luma block does not use the intraTMP), it is determined that the DM mode is used, that is, the intra prediction mode of the chroma block is determined based on the intra prediction mode of the corresponding luma block.
4. In response to DMflag=0, it is determined that it is not the DM mode and not the DBV mode, and the DIMD mode is decoded. The decoder analyzes a gradient of a reconstructed part by using the reconstructed part around the current block, converts the gradient into an angle in an angle mode, and uses the angle mode to predict the current block.
5. None of the above intra prediction modes are used, other traditional prediction modes are decoded, which includes those not used in 2 to 4 above.

The beneficial effects of adopting the above technical solution include following content.
(1) In a case where there is a luma block using the IBC or the intraTMP in the luma region corresponding to the chroma block under the dual tree partitioning, and a block vector found in a predefined order is used, the use of DM technology is skipped due to the intraDBV technology being allowed in this case.
(2) The intraDBV technology is expanded to the use of the single tree. Under the single tree, in response to the luma region at the position corresponding to the chroma block uses the intraTMP and there is an available block vector, the intraDBV may use its block vector to derive a block vector for prediction of the chroma and use the derived block vector for prediction.
(3) Since the DM prediction mode and the intraDBV mode of the chroma have certain functional redundancy, a DMflag flag may be used for representing enablement of the intraDBV at the same time, and the intraDBV flag may be cancelled.

In an embodiment of the present disclosure, referring to FIG. 8, a schematic flowchart of an encoding method provided in the embodiments of the present disclosure is illustrated. As illustrated in FIG. 8, the method may include following operations.

In operation 801, prediction mode reference information of a current chroma block is obtained.

It should be noted that the prediction mode reference information is used for determining an intra prediction mode of the current chroma block.

In some embodiments, the prediction mode reference information includes relevant information of a luma block corresponding to the current chroma block. Exemplarily, the prediction mode reference information may be intra prediction mode information of the luma block corresponding to the current chroma block.

In some embodiments, the prediction mode reference information may further include a partitioning mode of a picture unit where the current chroma block is located. Exemplarily, the picture unit where the current chroma block is located may be a current coding tree unit (CTU), or may be a current frame or other coding units. The partitioning mode is used for indicating the partitioning tree structure used for the luma block and the chroma block when coding an intra-frame. The partitioning tree structure may be a single tree structure or a dual tree structure.

In some embodiments, obtaining the prediction mode reference information of the current chroma block includes: partitioning, by using a single tree structure, a luma block and a chroma block in a picture unit where the current chroma block is located, and obtaining a prediction mode of a first luma block corresponding to the current chroma block; in a case where the prediction mode of the first luma block is a third intra prediction mode, determining that the luma block corresponding to the current chroma block uses the third intra prediction mode; in a case where the prediction mode of the first luma block is not the third intra prediction mode, determining that the luma block corresponding to the current chroma block does not use the third intra prediction mode.

In some embodiments, obtaining the prediction mode reference information of the current chroma block includes: partitioning, by using a dual tree structure, a luma block and a chroma block in a picture unit where the current chroma block is located, and searching for luma blocks at multiple positions in a first order in a luma region corresponding to the current chroma block; in a case where a first luma block whose prediction mode is the third intra prediction mode is searched out, determining that the luma block corresponding to the current chroma block uses the third intra prediction mode; and in a case where no luma block whose prediction mode is the third intra prediction mode is searched out, determining that the luma block corresponding to the current chroma block does not use the third intra prediction mode.

In some embodiments, the prediction mode reference information may further include a size of the current chroma block and relevant syntax elements of the current chroma block.

In operation 802, in a case where the prediction mode reference information meets a usage condition of the first intra prediction mode, a first syntax element flag is encoded.

It should be noted that the usage condition of the first intra prediction mode is used for determining whether the current chroma block is capable of using the first intra prediction mode. Exemplarily, the first intra prediction mode may be any chroma intra prediction mode. For example, the first intra prediction mode may be a chroma direct derived block vector prediction mode (i.e., the intraDBV mode) or a chroma direct derived prediction mode (i.e., the DM mode).

In some embodiments, in a case where the prediction mode reference information includes the intra prediction mode information of the luma block corresponding to the current chroma block, the usage condition may include: the luma block corresponding to the current chroma block using a third intra prediction mode. That is, in a case where the intra prediction mode of the luma block corresponding to the current chroma block is the third intra prediction mode, it is determined that the current chroma block is capable of using the first intra prediction mode; otherwise, it is determined that the current chroma block cannot use the first intra prediction mode.

Exemplarily, the first intra prediction mode is the intraDBV mode, and the third intra prediction mode may be the IBC mode or the intra TMP mode.

Exemplarily, the first intra prediction mode is the DM mode, and the third intra prediction mode may be a traditional intra prediction mode, such as the planar mode, the DC mode, or the angular prediction mode.

In some embodiments, the prediction mode reference information includes: the partitioning mode of the picture unit where the current chroma block is located; and the usage condition further includes: the partitioning mode of the picture unit where the current chroma block is located being a dual tree structure.

In some embodiments, the prediction mode reference information includes: the partitioning mode of the picture unit where the current chroma block is located; and the usage condition further includes: the partitioning mode of the picture unit where the current chroma block is located is being a single tree structure.

It should be noted that in a case where the prediction mode reference information does not include the partitioning mode of the picture unit where the current chroma block is located, the usage condition does not limit the partitioning mode, that is, the first intra prediction mode is applicable to any partitioning mode.

In operation 803, it is determined, based on the first syntax element flag, whether the current chroma block uses the first intra prediction mode.

It should be noted that the first syntax element flag is used for indicating whether the current chroma block uses the first intra prediction mode. Exemplarily, in a case where the first syntax element flag is a first value, it is determined that the current chroma block does not use the first intra prediction mode; in a case where the first syntax element flag is a second value, it is determined that the current chroma block uses the first intra prediction mode.

Furthermore, in some embodiments, the first intra prediction mode is the chroma direct derived block vector prediction mode (i.e., the intraDBV), and the method further includes: in a case of determining that the current chroma block uses the first intra prediction mode, obtaining a block vector of a first luma block corresponding to the current chroma block; determining, based on the block vector of the first luma block, a block vector of the current chroma block; and determining, based on the block vector of the current chroma block, a first prediction block of the current chroma block.

Exemplarily, in a case where the current chroma block is predicted by using the intraDBV, as illustrated in FIG. 3, under the dual tree partitioning, the chroma block finds a corresponding luma region, and checks whether there is at least one of luma blocks at the following five positions (C->TL->TR->BL->BR) in a first order using the IBC mode or the intraTMP mode. In a case where the at least one of luma blocks at these five positions uses the IBC or the intraTMP, the first block vector found in the first order (C->TL->TR->BL->BR) is used for deriving a chroma block vector, and a reconstructed block at the position pointed to by the chroma block vector is used for predicting the current chroma block.

In some implementations, determining, based on the block vector of the first luma block, the block vector of the current chroma block includes: downsampling the block vector of the first luma block, to determine a downsampled block vector; and performing a fine search based on the downsampled block vector, to determine the block vector of the current chroma block. Exemplarily, a fine search based on template matching is performed based on the downsampled block vector, to determine the best block vector for the current chroma block.

It should be noted that, in a case of determining that the current chroma block uses the first intra prediction mode, other syntax elements related to the first intra prediction mode may further be encoded, to further determine other sub-modes of the current chroma block.

In some embodiments, the method further includes: in a case of determining that the current chroma block uses the first intra prediction mode, encoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or a type of the weighted prediction mode in a case where the weighted prediction mode is used; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In operation 804, in a case where the prediction mode reference information does not meet the usage condition of the first intra prediction mode, a second syntax element flag is encoded.

In operation 805, it is determined, based on the second syntax element flag, whether the current chroma block uses the second intra prediction mode.

It should be noted that the second syntax element flag is used for indicating whether the current chroma block uses the second intra prediction mode. Exemplarily, in a case where the second syntax element flag is a first value, it is determined that the current chroma block does not use the second intra prediction mode; in a case where the second syntax element flag is a second value, it is determined that the current chroma block uses the second intra prediction mode.

Furthermore, in some embodiments, the second intra prediction mode is the chroma direct derived prediction mode (i.e., the DM), and the method further includes: in a case of determining that the current chroma block uses the second intra prediction mode, obtaining an intra prediction mode of a luma block corresponding to the current chroma block; taking the intra prediction mode of the luma block as the intra prediction mode of the current chroma block; and determining, based on the intra prediction mode of the current chroma block, a first prediction block of the current chroma block.

It should be noted that in a case of determining that the current chroma block uses the DM mode, the luma block corresponding to the current chroma block does not use the third intra prediction mode, that is, there is no available BV for the luma block corresponding to the current chroma block, and the intra prediction mode of the luma block may be directly used as the intra prediction mode of the current chroma block. These modes may be the traditional intra prediction modes, such as the planar mode, the DC mode, or the angular prediction mode.

It should be noted that, in a case of determining that the current chroma block uses the second intra prediction mode, other syntax elements related to the second intra prediction mode may further be encoded, to further determine other sub-modes of the current chroma block.

In some embodiments, the method further includes: in a case of determining that the current chroma block uses the second intra prediction mode, encoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or the type of the weighted prediction mode in a case of using the weighted prediction mode; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In some embodiments, the method further includes: encoding a syntax element flag of a cross-component intra prediction mode; determining, based on the syntax element flag of the cross-component intra prediction mode, that the current chroma block uses the cross-component intra prediction mode, and encoding cross-component intra prediction mode information; and determining, based on the syntax element flag of the cross-component intra prediction mode, that the current chroma block does not use the cross-component intra prediction mode, and determining whether the prediction mode reference information meets the usage condition of the first intra prediction mode.

That is, before encoding the first syntax element flag and the second syntax element flag, the syntax element flag of the cross-component intra prediction mode of the current chroma block is encoded first, and it is first determined, based on the syntax element flag, whether the current chroma block uses the cross-component intra prediction mode. If the current chroma block does not use the cross-component intra prediction mode, it is further determined, based on the prediction mode reference information, whether to encode the first syntax element flag or the second syntax element flag.

In some embodiments, the method further includes: in a case where the prediction mode reference information meets a usage condition of the first intra prediction mode, determining that the second syntax element flag is a preset value for indicating that the current chroma block does not use the second intra prediction mode; and in a case where the prediction mode reference information does not meet the usage condition of the first intra prediction mode, determining that the first syntax element flag is a preset value for indicating that the current chroma block does not use the first intra prediction mode.

In some embodiments, the method may further include: in a case of determining, based on the first syntax element flag, that the current chroma block does not use the first intra prediction mode, and determining, based on the second syntax element flag, that the current chroma block does not use the second intra prediction mode, encoding other syntax element flags of the current chroma block; and determining, based on the other syntax element flags, other intra prediction modes of the current chroma block.

That is, in a case where the intra prediction mode of the current chroma block cannot be determined based on the first syntax element flag and the second syntax element flag, other intra prediction modes are further encoded. Exemplarily, other intra prediction modes may be the DIMD mode, the planar mode, the DC mode or the angular prediction mode.

For example, the description of the relevant syntax elements of an intra coded chroma coding unit is shown in the Table 2-1 and the Table 2-2.

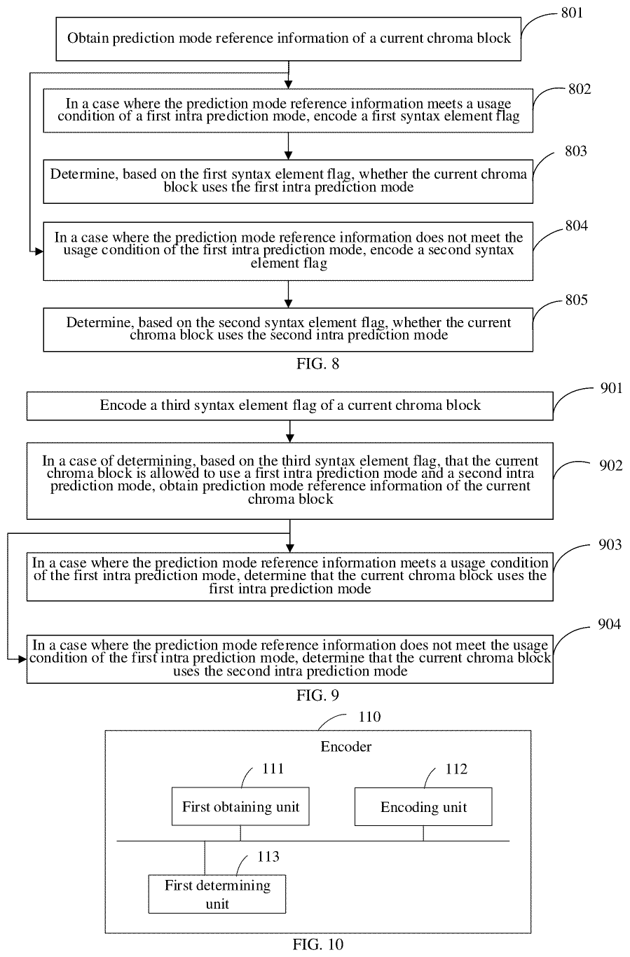

In another embodiment of the present disclosure, referring to FIG. 9, a schematic flowchart of another encoding method provided in the embodiments of the present disclosure. As illustrated in FIG. 9, the method may include following operations.

In operation 901, a third syntax element flag of a current chroma block is encoded.

It should be noted that the third syntax element flag is used to indicate whether a first intra prediction mode and a second intra prediction mode are allowed to be used. That is, in the embodiments of the present disclosure, a syntax element flag may be used to simultaneously indicate that the first intra prediction mode and the second intra prediction mode are used, or indicate that the first intra prediction mode and the second intra prediction mode are not used.

Exemplarily, in a case where the third syntax element flag is a first value, it is determined that the current chroma block does not use the first intra prediction mode and the second intra prediction mode; and in a case where the third syntax element flag is a second value, it is determined that the current chroma block uses the first intra prediction mode and the second intra prediction mode.

Exemplarily, the third syntax element may be an existing syntax element, that is, a usage situation of the first intra prediction mode and the second intra prediction mode is indicated by extending meaning of the existing syntax element. For example, the third syntax element flag may be a DM flag used for enabling the DM mode.

Exemplarily, the third syntax element may also be a newly added syntax element.

In a case where the third syntax element indicates that the first intra prediction mode and the second intra prediction mode are allowed to be used, it is determined whether the prediction mode reference information meets a usage condition of the first intra prediction mode. In a case where the prediction mode reference information meets the usage condition of the first intra prediction mode, it may be directly determined that the current chroma block uses the first intra prediction mode. In a case where the prediction mode reference information does not meet the usage condition of the first intra prediction mode, it is determined that the current chroma block uses the second intra prediction mode. In this way, in a case of encoding and decoding a chroma component, the third syntax element flag is used for enabling these two intra prediction modes, thereby reducing encoding and decoding bits.

In operation 902, in a case of determining, based on the third syntax element flag, that the current chroma block is allowed to use a first intra prediction mode and a second intra prediction mode, prediction mode reference information of the current chroma block is obtained.

It should be noted that the prediction mode reference information is used for determining an intra prediction mode of the current chroma block.

In some embodiments, the prediction mode reference information includes relevant information of a luma block corresponding to the current chroma block. Exemplarily, the prediction mode reference information may be intra prediction mode information of the luma block corresponding to the current chroma block.

In some embodiments, the prediction mode reference information may further include a partitioning mode of a picture unit where the current chroma block is located. Exemplarily, the picture unit where the current chroma block is located may be a current coding tree unit (CTU), or may be a current frame or other coding units. The partitioning mode is used for indicating the partitioning tree structure used for the luma block and the chroma block when coding an intra-frame. The partitioning tree structure may be a single tree structure or a dual tree structure.

In some embodiments, obtaining the prediction mode reference information of the current chroma block includes: partitioning, by using a single tree structure, a luma block and a chroma block in a picture unit where the current chroma block is located, and obtaining a prediction mode of a first luma block corresponding to the current chroma block; in a case where the prediction mode of the first luma block is a third intra prediction mode, determining that the luma block corresponding to the current chroma block uses the third intra prediction mode; in a case where the prediction mode of the first luma block is not the third intra prediction mode, determining that the luma block corresponding to the current chroma block does not use the third intra prediction mode.

In some embodiments, obtaining the prediction mode reference information of the current chroma block includes: partitioning, by using a dual tree structure, a luma block and a chroma block in a picture unit where the current chroma block is located, and searching for luma blocks at multiple positions in a first order in a luma region corresponding to the current chroma block; in a case where a first luma block whose prediction mode is the third intra prediction mode is searched out, determining that the luma block corresponding to the current chroma block uses the third intra prediction mode; and in a case where no luma block whose prediction mode is the third intra prediction mode is searched out, determining that the luma block corresponding to the current chroma block does not use the third intra prediction mode.

In some embodiments, the prediction mode reference information may further include a size of the current chroma block and relevant syntax elements of the current chroma block.

In operation 903, in a case where the prediction mode reference information meets a usage condition of the first intra prediction mode, it is determined that the current chroma block uses the first intra prediction mode.

It should be noted that the usage condition of the first intra prediction mode is used for determining whether the current chroma block is capable of using the first intra prediction mode. Exemplarily, the first intra prediction mode may be any chroma intra prediction mode. For example, the first intra prediction mode may be a chroma direct derived block vector prediction mode (i.e., the intraDBV mode) or a chroma direct derived prediction mode (i.e., the DM mode).

In some embodiments, in a case where the prediction mode reference information includes the intra prediction mode information of the luma block corresponding to the current chroma block, the usage condition may include: the luma block corresponding to the current chroma block using a third intra prediction mode. That is, in a case where the intra prediction mode of the luma block corresponding to the current chroma block is the third intra prediction mode, it is determined that the current chroma block is capable of using the first intra prediction mode; otherwise, it is determined that the current chroma block cannot use the first intra prediction mode.

Exemplarily, the first intra prediction mode is the intraDBV mode, and the third intra prediction mode may be the IBC mode or the intraTMP mode.

Exemplarily, the first intra prediction mode is the DM mode, and the third intra prediction mode may be a traditional intra prediction mode, such as the planar mode, the DC mode, or the angular prediction mode.

In some embodiments, the prediction mode reference information includes: the partitioning mode of the picture unit where the current chroma block is located; and the usage condition further includes: the partitioning mode of the picture unit where the current chroma block is located bring a dual tree structure.

In some embodiments, the prediction mode reference information includes: the partitioning mode of the picture unit where the current chroma block is located; and the usage condition further includes: the partitioning mode of the picture unit where the current chroma block is located being a single tree structure.

It should be noted that in a case where the prediction mode reference information does not include the partitioning mode of the picture unit where the current chroma block is located, the usage condition does not limit the partitioning mode, that is, the first intra prediction mode is applicable to any partitioning mode.

Furthermore, in some embodiments, the first intra prediction mode is the chroma direct derived block vector prediction mode (i.e., the intraDBV), and the method further includes: in a case of determining that the current chroma block uses the first intra prediction mode, obtaining a block vector of a first luma block corresponding to the current chroma block; determining, based on the block vector of the first luma block, a block vector of the current chroma block; and determining, based on the block vector of the current chroma block, a first prediction block of the current chroma block.

Exemplarily, in a case where the current chroma block is predicted by using the intraDBV, as illustrated in FIG. 3, under the dual tree partitioning, the chroma block finds a corresponding luma region, and checks whether there is at least one of luma blocks at the following five positions (C->TL->TR->BL->BR) in a first order using the IBC mode or the intraTMP mode. In a case where the at least one of luma blocks at these five positions uses the IBC or the intraTMP, the first block vector found in the first order (C->TL->TR->BL->BR) is used for deriving a chroma block vector, and a reconstructed block at the position pointed to by the chroma block vector is used for predicting the current chroma block.

In some implementations, determining, based on the block vector of the first luma block, the block vector of the current chroma block includes: downsampling the block vector of the first luma block, to determine a downsampled block vector; and performing a fine search based on the downsampled block vector, to determine the block vector of the current chroma block. Exemplarily, a fine search based on template matching is performed based on the downsampled block vector, to determine the best block vector for the current chroma block.

It should be noted that, in a case of determining that the current chroma block uses the first intra prediction mode, other syntax elements related to the first intra prediction mode may further be encoded, to further determine other sub-modes of the current chroma block.

In some embodiments, the method further includes: in a case of determining that the current chroma block uses the first intra prediction mode, encoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or a type of the weighted prediction mode in a case where the weighted prediction mode is used; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction modes may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In operation 904, in a case where the prediction mode reference information does not meet the usage condition of the first intra prediction mode, it is determined that the current chroma block uses the second intra prediction mode.

Furthermore, in some embodiments, the second intra prediction mode is the chroma direct derived prediction mode (i.e., the DM), and the method further includes: in a case of determining that the current chroma block uses the second intra prediction mode, obtaining an intra prediction mode of a luma block corresponding to the current chroma block; taking the intra prediction mode of the luma block as the intra prediction mode of the current chroma block; and determining, based on the intra prediction mode of the current chroma block, a first prediction block of the current chroma block. These modes may be traditional intra prediction modes, such as the planar mode, the DC mode, or the angular prediction mode.

It should be noted that, in a case of determining that the current chroma block uses the second intra prediction mode, other syntax elements related to the second intra prediction mode may further be encoded, to further determine other sub-modes of the current chroma block.

In some embodiments, the method further includes: in a case of determining that the current chroma block uses the second intra prediction mode, encoding a syntax element flag of a weighted prediction mode of the current chroma block; determining, based on the syntax element flag of the weighted prediction mode, a fourth intra prediction mode used for weighted prediction of the current chroma block; determining a second prediction block obtained by using the fourth intra prediction mode for the current chroma block; and performing weighting based on the first prediction block and the second prediction block, to obtain a final prediction block of the current chroma block.

Exemplarily, the syntax element flag of the weighted prediction mode may be used for indicating at least one of: whether to use the weighted prediction mode, or the type of the weighted prediction mode in a case of using the weighted prediction mode; where the type of the weighted prediction mode is used for indicating the weighting factor and the fourth intra prediction mode.

In some embodiments, the type of the weighted prediction mode is used for indicating the weighting factor and the fourth intra prediction mode. Exemplarily, the type of the weighted prediction mode may include: weighting without using the prediction result of the cross-component mode, weighting with the prediction result of the MMLM mode, weighting using one set of adaptive weights and the luma reconstructed value, and weighting using two sets of adaptive weights and the luma reconstructed value.

In some embodiments, the type of the weighted prediction mode may further include: weighting with a prediction result of the CCLM mode, weighting with a prediction result of the CCCM mode, and weighting with prediction results of multiple CCCM modes. That is, the fourth intra prediction mode may be a cross-component intra prediction mode. For example, the fourth intra prediction mode may be the CCLM mode, the MMLM mode, or the CCCM mode. The fourth intra prediction mode may also be a prediction mode that performs weighting using the luma reconstructed value.

In some embodiments, the method further includes: encoding a syntax element flag of a cross-component intra prediction mode; determining, based on the syntax element flag of the cross-component intra prediction mode, that the current chroma block uses the cross-component intra prediction mode, and encoding the cross-component intra prediction mode information; and determining, based on the syntax element flag of the cross-component intra prediction mode, that the current chroma block does not use the cross-component intra prediction mode, and encoding a third syntax element flag.

That is, before encoding the third syntax element flag, the syntax element flag of the cross-component intra prediction mode of the current chroma block is encoded first, and it is first determined, based on the syntax element flag, whether the current chroma block uses the cross-component intra prediction mode. If the current chroma block does not use the cross-component intra prediction mode, the third syntax element flag is further encoded.

In some embodiments, the method further includes: determining, based on the syntax element flag of the cross-component intra prediction mode, that the current chroma block uses the cross-component intra prediction mode, and determining that the third syntax element flag is a preset value for indicating that the current chroma block does not use the first intra prediction mode and the second intra prediction mode.

In some embodiments, the method may further include: in a case of determining, based on the third syntax element flag, that the current chroma block is not allowed to use the first intra prediction mode and the second intra prediction mode, encoding other syntax element flags of the current chroma block, and determining, based on the other syntax element flags, other intra prediction modes of the current chroma block.

That is, in a case of determining, based on the third syntax element flag, that the current chroma block does not use the first intra prediction mode and the second intra prediction mode, other intra prediction modes are further encoded. Exemplarily, the other intra prediction modes may be the DIMD mode, the planar mode, the DC mode or the angular prediction mode.

For example, the description of the relevant syntax elements of an intra coded chroma coding unit is shown in the Table 2-3.

In yet another embodiment of the present disclosure, a bitstream is further provided, where the bitstream is generated by bit encoding based on information to be encoded; and the information to be encoded includes at least one of:
a first syntax element flag used for indicating whether to use a first intra prediction mode, a second syntax element flag used for indicating whether to use a second intra prediction mode, a third syntax element flag used for indicating whether the first intra prediction mode and the second intra prediction mode are allowed to be used, a syntax element flag used for indicating a weighted prediction mode, other syntax element flags used for indicating other intra prediction modes, or a syntax element flag used for indicating a cross-component intra prediction mode.

It should be noted that the bitstream only includes one of the first syntax element flag or the second syntax element flag.

In yet another embodiment of the present disclosure, based on the same inventive concept as the above embodiments, referring to FIG. 10, a schematic diagram of a composition structure of an encoder provided in the embodiments of the present disclosure is illustrated. As illustrated in FIG. 10, the encoder 110 may include: a first obtaining unit 111, an encoding unit 112 and a first determining unit 113.

In some embodiments, the first obtaining unit 111 is configured to obtain prediction mode reference information of a current chroma block;
the encoding unit 112 is configured to: in a case where the prediction mode reference information meets a usage condition of a first intra prediction mode, encode a first syntax element flag; and
the first determining unit 113 is configured to determine, based on the first syntax element flag, whether the current chroma block uses the first intra prediction mode;
where the encoding unit 112 is further configured to: in a case where the prediction mode reference information does not meet the usage condition of the first intra prediction mode, encode a second syntax element flag; and
the first determining unit 113 is further configured to: determine, based on the second syntax element flag, whether the current chroma block uses a second intra prediction mode.

In some embodiments, an encoding unit 112 is configured to encode a third syntax element flag of a current chroma block;
the first obtaining unit 111 is configured to: in a case of determining, based on the third syntax element flag, that the current chroma block is allowed to use a first intra prediction mode and a second intra prediction mode, obtain prediction mode reference information of the current chroma block; and
the first determining unit 113 is configured to: in a case where the prediction mode reference information meets a usage condition of the first intra prediction mode, determine that the current chroma block uses the first intra prediction mode,
where the first determining unit 113 is further configured to: in a case where the prediction mode reference information does not meet the usage condition of the first intra prediction mode, determine that the current chroma block uses the second intra prediction mode.

It may be understood that various functional units of the encoder further perform the encoding method according to any one of the above embodiments, which will not be repeated here in detail.

It may be understood that in the embodiments of the present disclosure, a “unit” may be a part of a circuit, a part of a processor, a part of a program or software, or the like, and may also be a module or a non-module. Furthermore, various components in the embodiments may be integrated into one processing unit, or various units may exist physically separately, or two or more units may be integrated into one unit. The above integrated unit may be implemented in the form of hardware or in the form of software function modules.

If the integrated units are implemented in the form of a software function module and is not sold or used as an independent product, they may be stored in a non-transitory computer-readable storage medium. Based on such an understanding, the technical solution of the embodiments is essentially or the part that contributes to the prior art or all or part of the technical solution may be embodied in the form of a software product. The computer software product is stored in a storage medium and includes the number of instructions for enabling a computer device (which may be a personal computer, a server, or a network device, or the like.) or a processor to perform all or part of the operations of the methods of the embodiments. The above storage media include: a U disk, a mobile hard disk, a read only memory (ROM), a random access memory (RAM), a disk, a compact disc (CD) or other media that may store program code.

Therefore, a non-transitory computer-readable storage medium is provided in the embodiments of the present disclosure, which is applied to the encoder 110. The non-transitory computer-readable storage medium stores a computer program, and when the computer program is executed by the first processor, the encoding method according to any one of the above embodiments is implemented.

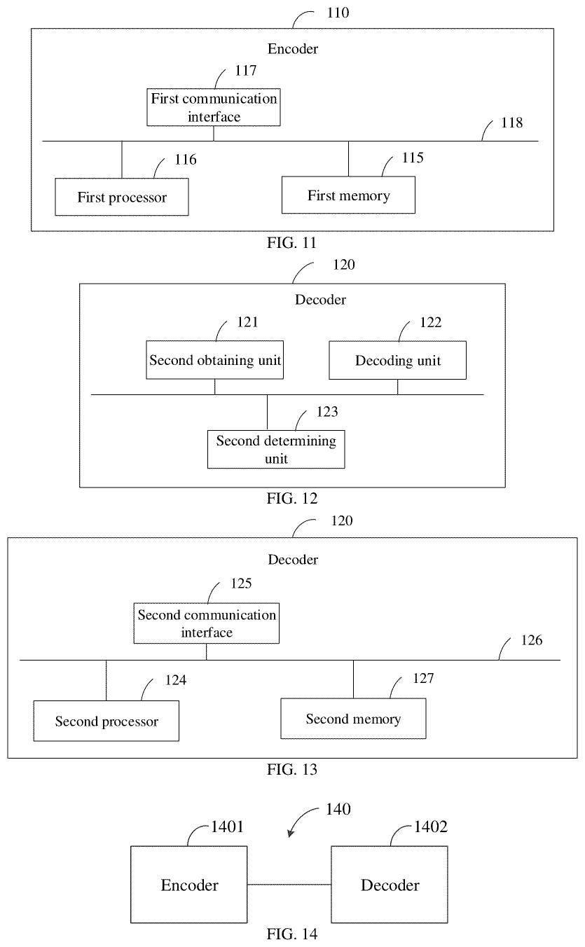

Based on the composition of the encoder 110 and the non-transitory computer-readable storage medium, referring to FIG. 11, a schematic diagram of a hardware structure of the encoder 110 provided in the embodiments of the present disclosure is illustrated. As illustrated in FIG. 11, the encoder 110 may include: a first memory 115, a first processor 116, a first communication interface 117, and a first bus system 118. The first memory 115, the first processor 116, and the first communication interface 117 are coupled together via a first bus system 118. It may be understood that the first bus system 118 is used to achieve connection and communication between these components. The first bus system 118 includes not only a data bus but also a power bus, a control bus, and a status signal bus. However, for the sake of clarity, various buses are labeled as the first bus system 118 in FIG. 20, where
the first communication interface 117 is configured to receive and send signals during the process of sending information to other external network elements and receiving the information from other external network elements; and
the first memory 115 is configured to store a computer program executable on a first processor.

In some embodiments, the first processor 116 is configured to: when running a computer program, perform following operations:
obtaining prediction mode reference information of the current chroma block;
in a case where the prediction mode reference information meets a usage condition of the first intra prediction mode, encoding a first syntax element flag;
determining, based on the first syntax element flag, whether the current chroma block uses a first intra prediction mode;
in a case where the prediction mode reference information does not meet the usage condition of the first intra prediction mode, encoding a second syntax element flag; and
determining, based on the second syntax element flag, whether the current chroma block uses a second intra prediction mode.

In some embodiments, the first processor 116 is configured to: when running a computer program, perform following operations:
encoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

It may be understood that the first memory 115 in the embodiments of the present disclosure may be a volatile (transitory) memory or a non-volatile (non-transitory) memory, or may include both volatile and non-volatile memories. The non-volatile memory may be a read-only memory (ROM), a programmable ROM (PROM), an erasable PROM (EPROM), an electrically EPROM (EEPROM) or a flash memory. The volatile memory may be a random access memory (RAM), which is used as an external cache. As an example but not limitation, a variety of forms of RAMs are available, such as a static RAM (SRAM), a dynamic RAM (DRAM), a synchronous DRAM (SDRAM), a double data rate SDRAM, (DDR SDRAM), an enhanced SDRAM (ESDRAM), a synchlink DRAM (SLDRAM) and a direct rambus RAM (DR RAM). The first memory 115 of the systems and methods described here is intended to include, but is not limited to, these and any other suitable types of memories.

The first processor 116 may be an integrated circuit chip with signal processing capabilities. In the implementation process, various operations in the above methods may be completed by an integrated logic circuit of hardware in the first processor 116 or by instructions in software form. The first processor 116 may be a general purpose processor, a digital signal processor (DSP), an application specific integrated circuit (ASIC), a field programmable gate array (FPGA) or other programmable logic device, a discrete gate, a transistor logic device, or a discrete hardware component, which may implement or perform the disclosed methods, operations and logic block diagrams in the embodiments of the present disclosure. The general purpose processor may be a microprocessor, or the processor may be any conventional processor. The operations of the methods disclosed in conjunction with the embodiments of the present disclosure may be directly implemented as being performed by the hardware decoding processor, or may be implemented by a combination of the hardware and software modules in the decoding processor. The software module may be located in a random memory, a flash memory, a read-only memory, a programmable read-only memory, an electrically erasable programmable memory, a register or other mature storage media in the art. The storage medium is located in the first memory 115, and the first processor 116 reads the information in the first memory 115 and completes the operations of the above methods in combination with its hardware.

It will be understood that the embodiments described here may be implemented by hardware, software, firmware, middleware, microcode, or a combination thereof. For hardware implementation, the processing unit may be implemented in one or more application specific integrated circuits (ASICs), digital signal processors (DSPs), digital signal processing devices (DSPDs), programmable logic devices (PLDs), field programmable gate arrays (FPGAs), general-purpose processors, controllers, microcontrollers, microprocessors, other electronic units used for performing the functions described in the present disclosure, or combinations thereof. For software implementation, the technology described in the present disclosure may be implemented through modules (e.g., procedures, functions.) that perform the functions described in the present disclosure. The software codes may be stored in a memory and performed by a processor. The memory may be implemented within the processor or external to the processor.

Optionally, as another embodiment, the first processor 116 is further configured to perform the encoding method according to any one of the above embodiments when running the computer program.

The embodiments provide an encoder, for the encoder, reconstructed block information of different matching templates is fully utilized during a search process for the reconstructed region, rather than reconstructed block information corresponding to a template with the lowest matching cost being simply considered, thereby improving prediction accuracy and encoding efficiency. Furthermore, the matching template information is fully utilized to adaptively assign weighting factors to a reference block, it is considered that different pieces of reconstructed block information have different importance to predicting the current block, the prediction accuracy and encoding efficiency are further improved.

In yet another embodiment of the present disclosure, based on the same inventive concept as the above embodiments, referring to FIG. 12, a schematic diagram of a composition structure of a decoder 120 provided in the embodiments of the present disclosure is illustrated. As illustrated in FIG. 12, the decoder 120 may include: a second obtaining unit 121, a decoding unit 122, and a second determining unit 123.

In some embodiments, the second obtaining unit 121 is configured to obtain prediction mode reference information of a current chroma block;
the decoding unit 122 is configured to: in a case where the prediction mode reference information meets a usage condition of a first intra prediction mode, decode a first syntax element flag; and
the second determining unit 123 is configured to determine, based on the first syntax element flag, whether the current chroma block uses the first intra prediction mode,
where the decoding unit 122 is further configured to: in a case where the prediction mode reference information does not meet the usage condition of the first intra prediction mode, decode a second syntax element flag; and
the second determining unit 123 is further configured to determine, based on the second syntax element flag, whether the current chroma block uses a second intra prediction mode.

In some embodiments, the decoding unit 122 is configured to decode a third syntax element flag of a current chroma block;
the second obtaining unit 121 is configured to: in a case of determining, based on the third syntax element flag, that the current chroma block is allowed to use a first intra prediction mode and a second intra prediction mode, obtain prediction mode reference information of the current chroma block; and
the second determining unit 123 is configured to: in a case where the prediction mode reference information meets a usage condition of the first intra prediction mode, determine that the current chroma block uses the first intra prediction mode,
where the second determining unit 123 is further configured to: in a case where the prediction mode reference information does not meet the usage condition of the first intra prediction mode, determine that the current chroma block uses the second intra prediction mode.

It may be understood that various functional units of the decoder further perform the decoding method according to any one of the above embodiments, which will not be repeated here in detail here.

It may be understood that in the embodiments, a “unit” may be a part of a circuit, a part of a processor, a part of a program or software, or the like, and may also be a module or a non-module. Furthermore, various components in the embodiments may be integrated into one processing unit, or various units may exist physically separately, or two or more units may be integrated into one unit. The above integrated unit may be implemented in the form of hardware or in the form of software function modules.

If the integrated units are implemented in the form of a software function module and is not sold or used as an independent product, they may be stored in a non-transitory computer-readable storage medium. Based on such an understanding, a non-transitory computer-readable storage medium is provided in the embodiments, which is applied to the decoder 120. The non-transitory computer-readable storage medium stores a computer program. When the computer program is executed by the second processor, the decoding method according to any one of the above embodiments is implemented.

Based on the composition of the decoder 120 and the non-transitory computer-readable storage medium, referring to FIG. 13, a schematic diagram of a hardware structure of the decoder 120 provided in the embodiments of the present disclosure is illustrated. As illustrated in FIG. 13, the decoder 120 may include: a second memory 127, a second processor 124, a second communication interface 125, and a second bus system 126. The second memory 127, the second processor 124, and the second communication interface 125 are coupled together via a second bus system 126. It may be understood that the second bus system 126 is used to achieve connection and communication between these components. The second bus system 126 includes not only a data bus but also a power bus, a control bus, and a status signal bus. However, for the sake of clarity, various buses are labeled as the second bus system 126 in FIG. 22, where
the second communication interface 125 is configured to receive and send signals during the process of sending information to other external network elements and receiving the information from other external network elements; and
the second memory 127 is configured to store a computer programs executable on a second processor.

In some embodiments, the second processor 124 is configured to: when running a computer program, perform following operations:
obtaining prediction mode reference information of the current chroma block;
in a case where the prediction mode reference information meets a usage condition of the first intra prediction mode, decoding a first syntax element flag;
determining, based on the first syntax element flag, whether the current chroma block uses a first intra prediction mode;
in a case where the prediction mode reference information does not meet the usage condition of the first intra prediction mode, decoding a second syntax element flag; and
determining, based on the second syntax element flag, whether the current chroma block uses a second intra prediction mode.

In some embodiments, the second processor 124 is configured to: when running a computer program, perform following operations:
decoding a third syntax element flag of a current chroma block;
in a case of determining, based on the third syntax element flag, that the current chroma block is allowed to use a first intra prediction mode and a second intra prediction mode, obtaining prediction mode reference information of the current chroma block;
in a case where the prediction mode reference information meets a usage condition of the first intra prediction mode, determining that the current chroma block uses the first intra prediction mode; and
in a case where the prediction mode reference information does not meet the usage condition of the first intra prediction mode, determining that the current chroma block uses the second intra prediction mode.

Optionally, as another embodiment, the second processor 124 is further configured to perform the decoding method according to any one of the above embodiments when running the computer program.

It may be understood that hardware functions of the second memory 127 are similar as that of the first memory 115, and hardware functions of the second processor 124 are similar as that of the first processor 116, which will not be repeated here in detail.

The embodiments provide a decoder, for the decoder, reconstructed block information of different matching templates is fully utilized during a search process for the reconstructed region, rather than reconstructed block information corresponding to a template with the lowest matching cost being simply considered, thereby improving prediction accuracy and decoding efficiency. Furthermore, the matching template information is fully utilized to adaptively assign weighting factors to a reference block, it is considered that different pieces of reconstructed block information have different importance to predicting the current block, the prediction accuracy and decoding efficiency are further improved.

In yet another embodiment of the present disclosure, referring to FIG. 14, a schematic diagram of a composition structure of an encoding and decoding system provided in the embodiments of the present disclosure is illustrated. As illustrated in FIG. 14, the encoding and decoding system 140 may include an encoder 1401 and a decoder 1402.

In the embodiments of the present disclosure, the encoder 1401 may be the encoder according to any one of the above embodiments, and the decoder 1402 may be the decoder according to any one of the above embodiments.

It should be noted that, in the present disclosure, the terms “comprises”, “includes” or any other variations thereof are intended to cover non-exclusive inclusion, so that a process, a method, an article or an apparatus including a series of elements includes not only those elements, but also other elements not explicitly listed, or also includes elements inherent to such the process, the method, the article or the apparatus. Without more constraints, an element defined by the phrase “including a . . . ” does not exclude the existence of other identical elements in the process, the method, the article or the apparatus including the element.

The serial numbers of the above embodiments of the present disclosure are for description only and do not represent the advantages or disadvantages of the embodiments.

The methods disclosed in several method embodiments provided in the present disclosure may be arbitrarily combined without conflict, to obtain new method embodiments.

The features disclosed in several product embodiments provided in present disclosure may be arbitrarily combined without conflict, to obtain new product embodiments.

The features disclosed in several method embodiments or device embodiments provided in the present disclosure may be arbitrarily combined without conflict, to obtain new method embodiments or new device embodiments.

The foregoing descriptions are merely implementations of the present disclosure, but the protection scope of the present disclosure is not limited thereto. Any person skilled in the art may readily conceive of changes or replacements within the technical scope of the present disclosure, which shall be all included within the protection scope of the present disclosure. Therefore, the protection scope of the present disclosure shall be subject to the protection scope of claims.

### INDUSTRIAL APPLICABILITY

The embodiments of the present disclosure provide encoding and decoding methods, a bitstream, encoders, decoders, and a storage medium. In a case of encoding and decoding a chroma component, it is considered that there is functional redundancy of some intra prediction modes, in a case where prediction mode reference information meets an usage condition of the first intra prediction mode, only the first syntax element flag is encoded/decoded, it is determined whether the current chroma block uses the first intra prediction mode based on the first syntax element flag, and encoding/decoding of a syntax element flag related to the second intra prediction mode is skipped, that is, the current chroma block does not use the second intra prediction mode. In a case where the prediction mode reference information does not meet the usage condition of the first intra prediction mode, only the second syntax element flag is encoded/decoded, it is determined whether the current chroma block uses the second intra prediction mode based on the second syntax element flag; and encoding/decoding of a syntax element flag related to the first intra prediction mode is skipped, that is, the current chroma block does not use the first intra prediction mode. In this way, in a case of encoding and decoding the chroma component, encoding and decoding codewords of these two intra prediction modes are reduced, thereby improving compression efficiency.

In addition, the third syntax element flag may be used for simultaneously indicating whether the first intra prediction mode and the second intra prediction mode are allowed to be used. In a case that the first intra prediction mode and the second intra prediction mode are allowed to be used, it is determined whether the prediction mode reference information meets the usage condition of the first intra prediction mode. In a case that the prediction mode reference information meets the usage condition of the first intra prediction mode, it may be directly determined that the current chroma block uses the first intra prediction mode. In a case that the prediction mode reference information does not meet the usage condition of the first intra prediction mode, it is determined that the current chroma block uses the second intra prediction mode. In this way, in a case of encoding and decoding the chroma component, the third syntax element flag may be used for enabling these two intra prediction modes. Furthermore, same syntax element flag may be used to flag the same or similar prediction information in different intra prediction modes, which may also reduce the encoding and decoding codewords of the chroma prediction mode and improve the compression efficiency.

What is claimed is:

1. A decoding method, applied to a decoder, comprising:
obtaining prediction mode reference information of a current chroma block;
in a case where the prediction mode reference information meets a usage condition of a first intra prediction mode, decoding a first syntax element flag;
determining, based on the first syntax element flag, whether the current chroma block uses the first intra prediction mode;
in a case where the prediction mode reference information does not meet the usage condition of the first intra prediction mode, decoding a second syntax element flag; and
determining, based on the second syntax element flag, whether the current chroma block uses a second intra prediction mode.

2. The method according to claim 1, wherein the prediction mode reference information comprises: intra prediction mode information of a luma block corresponding to the current chroma block; and
the usage condition comprises: the luma block corresponding to the current chroma block using a third intra prediction mode.

3. The method according to claim 2, wherein the prediction mode reference information comprises: a partitioning mode of a picture unit where the current chroma block is located; and
the usage condition further comprises: the partitioning mode of the picture unit where the current chroma block is located being a dual tree structure.

4. The method according to claim 2, wherein obtaining the prediction mode reference information of the current chroma block comprises:
partitioning, by using a dual tree structure, a luma block and a chroma block in a picture unit where the current chroma block is located, and searching for luma blocks at multiple positions in a first order in a luma region corresponding to the current chroma block;
in a case where a first luma block whose prediction mode is the third intra prediction mode is searched out, determining that the luma block corresponding to the current chroma block uses the third intra prediction mode; and
in a case where no luma block whose prediction mode is the third intra prediction mode is searched out, determining that the luma block corresponding to the current chroma block does not use the third intra prediction mode.

5. The method according to claim 1, wherein the first intra prediction mode is a chroma direct derived block vector prediction mode, and the method further comprises:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

6. The method according to claim 5, wherein determining, based on the block vector of the first luma block, the block vector of the current chroma block comprises:
downsampling the block vector of the first luma block, to determine a downsampled block vector; and
performing a fine search based on the downsampled block vector, to determine the block vector of the current chroma block.

7. The method according to claim 5, further comprising:
in a case of determining that the current chroma block uses the first intra prediction mode, decoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

8. The method according to claim 1, wherein the second intra prediction mode is a chroma direct derived prediction mode, and the method further comprises:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

9. The method according to claim 8, further comprising:
in a case of determining that the current chroma block uses the second intra prediction mode, decoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

10. The method according to claim 2, wherein the third intra prediction mode is an intra block copy prediction mode or an intra template matching prediction mode.

11. The method according to claim 1, further comprising:
in a case of determining, based on the first syntax element flag, that the current chroma block does not use the first intra prediction mode, and determining, based on the second syntax element flag, that the current chroma block does not use the second intra prediction mode, decoding other syntax element flags of the current chroma block; and
determining, based on the other syntax element flags, other intra prediction modes of the current chroma block.

12. The method according to claim 1, further comprising:
decoding a syntax element flag of a cross-component intra prediction mode;
determining, based on the syntax element flag of the cross-component intra prediction mode, that the current chroma block uses the cross-component intra prediction mode, and decoding cross-component intra prediction mode information; and
determining, based on the syntax element flag of the cross-component intra prediction mode, that the current chroma block does not use the cross-component intra prediction mode, and determining whether the prediction mode reference information meets the usage condition of the first intra prediction mode.

13. An encoding method, applied to an encoder, comprising:
obtaining prediction mode reference information of a current chroma block;
in a case where the prediction mode reference information meets a usage condition of a first intra prediction mode, encoding a first syntax element flag;
determining, based on the first syntax element flag, whether the current chroma block uses the first intra prediction mode;
in a case where the prediction mode reference information does not meet the usage condition of the first intra prediction mode, encoding a second syntax element flag; and
determining, based on the second syntax element flag, whether the current chroma block uses a second intra prediction mode.

14. The method according to claim 13, wherein the prediction mode reference information comprises: intra prediction mode information of a luma block corresponding to the current chroma block; and
the usage condition comprises: the luma block corresponding to the current chroma block using a third intra prediction mode.

15. The method according to claim 14, wherein the prediction mode reference information comprises: a partitioning mode of a picture unit where the current chroma block is located; and
the usage condition further comprises: the partitioning mode of the picture unit where the current chroma block is located being a dual tree structure.

16. The method according to claim 13, wherein the first intra prediction mode is a chroma direct derived block vector prediction mode, and the method further comprises:
in a case of determining that the current chroma block uses the first intra prediction mode, obtaining a block vector of a first luma block corresponding to the current chroma block;
determining, based on the block vector of the first luma block, a block vector of the current chroma block; and
determining, based on the block vector of the current chroma block, a first prediction block of the current chroma block.

17. The method according to claim 16, wherein determining, based on the block vector of the first luma block, the block vector of the current chroma block comprises:
downsampling the block vector of the first luma block, to determine a downsampled block vector; and
performing a fine search based on the downsampled block vector, to determine the block vector of the current chroma block.

18. The method according to claim 16, further comprising:
in a case of determining that the current chroma block uses the first intra prediction mode, encoding a syntax element flag of a weighted prediction mode of the current chroma block;
determining, based on the syntax element flag of the weighted prediction mode, a fourth intra prediction mode used for weighted prediction of the current chroma block;
determining a second prediction block obtained by using the fourth intra prediction mode for the current chroma block; and
performing weighting based on the first prediction block and the second prediction block, to obtain a final prediction block of the current chroma block.

19. The method according to claim 13, wherein the second intra prediction mode is a chroma direct derived prediction mode, and the method further comprises:
in a case of determining that the current chroma block uses the second intra prediction mode, obtaining an intra prediction mode of a luma block corresponding to the current chroma block;
taking the intra prediction mode of the luma block as an intra prediction mode of the current chroma block; and
determining, based on the intra prediction mode of the current chroma block, a first prediction block of the current chroma block.

20. A non-transitory computer-readable storage medium, having a computer program and a bitstream stored thereon, wherein the computer program, when executed by a processor, enables the processor to perform the following operations to generate the bitstream:
obtaining prediction mode reference information of a current chroma block;
in a case where the prediction mode reference information meets a usage condition of a first intra prediction mode, encoding a first syntax element flag;
determining, based on the first syntax element flag, whether the current chroma block uses the first intra prediction mode;
in a case where the prediction mode reference information does not meet the usage condition of the first intra prediction mode, encoding a second syntax element flag; and
determining, based on the second syntax element flag, whether the current chroma block uses a second intra prediction mode.
